(19) United States
(12) Patent Application Publication
(10) Pub. No.: US 2013/0204962 A1
(43) Pub. Date: Aug. 8, 2013

(54) NETWORK AND PERIPHERAL INTERFACE CIRCUITS, SYSTEMS AND PROCESSES

(71) Applicants: Leonardo William Estevez, Rowlett, TX (US); Brijesh Mani Tripathi, Bangalore (IN); Sankar Prasad Debnath, Bangalore (IN); Ian James Sherlock, Dallas, TX (US)

(72) Inventors: Leonardo William Estevez, Rowlett, TX (US); Brijesh Mani Tripathi, Bangalore (IN); Sankar Prasad Debnath, Bangalore (IN); Ian James Sherlock, Dallas, TX (US)

(73) Assignee: TEXAS INSTRUMENTS INCORPORATED, Dallas, TX (US)

(21) Appl. No.: 13/364,647

(22) Filed: Feb. 2, 2012

(51) Int. Cl. G06F 15/16

(52) U.S. Cl. 709/217

(57) ABSTRACT

A networking device (810) includes user interface circuitry (838) operable for user input and display, a host processor (880) coupled with the user interface circuits (838); a network modem (870) and a peripheral interface processor (810) coupled with the host processor (880) and operable to automatically execute content receptions and transmission through the network modem (870) at least sometimes independently of the user interface circuits (838) and the host processor (880); and a local content storage (820) coupled with the peripheral interface processor (810) and wherein the peripheral interface processor (810) is operable with the modem (870) to transmit trigger signals representing controls to pull remote content from elsewhere and to subsequently receive such content via the modem (870) for the local content storage (820). Other network circuits, devices, systems and processes and peripheral interface circuits, devices, systems and processes are also disclosed.

### CROSS-REFERENCES TO RELATED APPLICATIONS

This application is related to U.S. Patent Application Publication 20110188391 “Interrelated Wi-Fi and USB Protocols and Other Application Framework Processes, Circuits and Systems” (TI-69048) dated Aug. 4, 2011, and which is incorporated herein by reference in its entirety.

This application is related to U.S. Patent Application Publication 20110065424 “System and Method to Facilitate Downloading Data at a Mobile Wireless Device” (TI-67861) dated Mar. 17, 2011, and which is incorporated herein by reference in its entirety.

This application is related to U.S. Pat. No. 8,036,703 “Image Capture Reporting Based on Content-Associated Wireless Identification” (TI-39297) dated Oct. 11, 2011, and which is incorporated herein by reference in its entirety.

This application is related to U.S. Patent Application Publication 20050125836 “Shared Wireless Video Downloading” (TI-33714) dated Jun. 9, 2005, which is incorporated herein by reference in its entirety.

### STATEMENT REGARDING FEDERALLY SPONSORED RESEARCH OR DEVELOPMENT

Not applicable.

### COPYRIGHT NOTIFICATION

Portions of this patent application contain materials that are subject to copyright protection. The copyright owner has no objection to the facsimile reproduction by anyone of the patent document, or the patent disclosure, as it appears in a governmental patent office to the extent they have a non-copyright right to do so, but otherwise reserves all copyright rights whatsoever.

### BACKGROUND

As the number of devices and amount of networking rises, the competition among devices for time and bandwidth on wireline and wireless networks becomes ever more burdensome and expensive. An important problem involves how to support high definition TV, cameras, displays, memory, sensor peripherals, etc. (see FIG. 1) in a way that minimizes mobile and other system power and cost for existing and emerging use cases too.

In one device example, and without limitation, mobile feature phones face issues and constraints of economic cost pressures as well as compute performance pressures when used with low-power but low-cost processors. Wireless network traffic can add computer burden, in addition to normal host processor functions and time-sensitive applications. Maintaining technological economy of such phones as more networked usage is demanded of them is plainly an important problem for the art.

New standards such as Wi-Fi Serial Bus (WUSB) leverage USB drivers and application profiles wirelessly over Wi-Fi connections. (USB is a wired master/slave protocol which handles user connection and disconnection of devices.) With the increased convenience come further demands on existing networking devices.

In addition, these devices are constrained by physical limitations such as miniature size and limited pins of their component integrated circuit chips. Small, inexpensive integrated circuit die can be made in advanced integrated circuit fabrication processes. However, small die impose a problem of reduced pins even as more functionality is demanded of these and other integrated circuit chips. Accordingly, substantial departures in networking devices and their processes are desirable and needed.

### SUMMARY OF THE INVENTION

Generally, and in one form of the invention, a networking device includes user interface circuits operable for user input and display, a host processor coupled with the user interface circuits; a network modem and a peripheral interface processor coupled with the host processor and operable to automatically execute content receptions and transmission through the network modem at least sometimes independently of the user interface circuits and the host processor; and a local content storage coupled with the peripheral interface processor and wherein the peripheral interface processor is operable with the modem to transmit trigger signals representing controls to pull remote content from elsewhere and to subsequently receive such content via the modem for the local content storage.

Generally, and in another form of the invention, a peripheral interface processor integrated circuit includes a networking modem operable to receive signals carrying station addresses; a plurality of data interface circuits; and a programmable processor coupled with the modem and the interface circuits and operable to act as a local station with its own station address, the processor operable to detect a received station address other than own station address, to determine whether that received address is among a set of predetermined station addresses, and to capture at least some content from signals addressed to such received address provided the received address is among that set of station addresses.

Generally, and in a process form of the invention of operating a networking circuit, the process includes detecting a received station address other than own station address, and capturing at least some content from signals addressed to such received address provided the received address is among a given set of station addresses.

Generally, and in a process form of the invention of operating a content-sharing network server, the process includes storing data beforehand that substantially represents a table indicating network stations of an electronic social group that may hold content remotely, receiving a station network address that corresponds to a station indicated in the table, and receiving with that address a data entity including file name of content, tagging the data entity with at least one identification indication of a station from the table, and automatically initiating a message to at least one station thus tagged, each such message including a link to the content thus tagged.

Generally, a further form of the invention involves an electronic circuit for a mobile device, the electronic circuit including a networking modem, a storage device operable to hold a content file; and a processor coupled with the networking modem to have a station MAC address and the processor coupled and operable with the storage device to store and tag such content file with at least one other MAC address, the processor further operable to make the storage device with tagged content file remotely discoverable upon receiving via the modem a remotely-originated discovery request including the other MAC address as originating MAC address of the discovery request.

Other network circuits, devices systems and processes and peripheral interface circuits, devices, systems and processes are also disclosed and claimed.

### BRIEF DESCRIPTION OF THE DRAWINGS

FIG. 1 is a pictorial of stations remotely sharing content, such as a game screen, video clip, work document, or other shared content according to embodiments in the other Figures.

FIG. 2A is a pictorial of mobile devices including a social network group of friends remotely sharing content according to embodiments in the other Figures.

FIG. 2B is a partially pictorial, partially block, diagram of a mobile device station communicating wirelessly with a docking station according to embodiments in the other Figures.

FIG. 3 is a block diagram of Wi-Fi wireless stations with peer-to-peer (P2P) Wi-Fi Direct connectivity.

FIG. 4 is a block diagram of a network embodiment of Wi-Fi wireless stations (STAs) operable to ‘sniff’ MAC (media access control) addresses for content and to perform content push/pull between them, and also connected with a social networking server showing a recordkeeping process embodiment, and including a more detailed block diagram of one of the stations and its operations.

FIG. 4A is a storage table diagram illustrating another recordkeeping process embodiment.

FIG. 4B is a storage table diagram illustrating still another recordkeeping process embodiment which can also be used to supplement recordkeeping of FIG. 4A.

FIG. 5 is a process flow diagram of a sniffing process embodiment for an STA in FIG. 4.

FIG. 6 is a process flow diagram of a peer content searching and pull-request process embodiment for a first Friend STA to trigger or request a file transfer from another Friend STA in FIG. 4 to the first STA.

FIG. 7 is a process flow diagram of a pull-response process embodiment for the other Friend STA to execute a file transfer from itself to the first Friend STA in FIGS. 4 and 6.

FIG. 8 is a process flow diagram of a push process embodiment for a Friend STA to initiate a file transfer to another Friend STA in FIG. 4.

FIG. 9 is a flow diagram of a process embodiment of networking support in the social networking server of FIG. 4 for content-sharing operations among socially-networked stations.

FIG. 10 is a diagram illustrating some Wi-Fi P2P signaling versus time in a beacon-to-beacon interval.

FIG. 11 is a block diagram of a networking device embodiment with chips or cores and other circuits such as for use in FIGS. 1-4.

FIG. 12 is a block diagram of another device embodiment and showing a power saving mode during transmission and reception of content.

FIG. 13 is a block diagram of the device embodiment of FIG. 12 with an application processor and a peripheral interface chip and other chips, cores and other circuits such as for use in FIGS. 1-4 and showing the power saving mode during viewing of locally-stored content, and further including a GPS receiver with power saving mode for low-power satellite positioning reception and position based applications.

FIG. 14 is a block diagram of yet another device embodiment with chips or cores and other circuits such as for use in FIGS. 1-4 and showing a multi-MAC WLAN embodiment operated by a host processor and a peripheral interface chip.

FIG. 15 is a partially pictorial, partially block diagram of a yet further device embodiment with chips or cores and other circuits such as for use in the other Figures and detailing important couplings.

FIG. 16 is a block diagram of a peripheral interface processor embodiment.

FIG. 17 is a block diagram of another peripheral interface processor embodiment.

FIG. 18 is a flow diagram of a process embodiment to start or initially constitute an electronic social group for a station STA such as a mobile device to use and communicate with a network server process of FIG. 19.

FIG. 19 is a flow diagram of a process embodiment for a network server in FIG. 4 to use in cooperation with the new social group process of FIG. 18, a join process of FIG. 20, and a request-to-join process of FIG. 21.

FIG. 20 is a flow diagram of a process embodiment a station STA responds to an invitation from the network server 150 to join a social group, or not.

FIG. 21 is a flow diagram of a process embodiment wherein a station STA initiates a request to join an existing social group.

FIG. 22 is a two-way communications diagram of a process of communications between a WUSB (wireless USB) host and a WUSB docking station and depicts WUSB session setup wherein process steps are shown as horizontal blocks of communications and the steps proceed over time in a downward direction.

FIG. 23 is a composite of two two-way communications diagrams of processes of communications between an Enrollee STA, a Wi-Fi AP and a Registrar, e.g. network server, and process steps are shown as horizontal lines of communications and the steps proceed over time in a downward direction.

FIG. 24 is a two-way communications diagram of a process of communications between a WUSB host and a WUSB docking station and depicts WUSB Reset, Device Capabilities and Device Handle Exchange, and process steps are shown as horizontal blocks of communications and the steps proceed over time in a downward direction.

FIG. 25 is a two-way communications diagram of a process of communications between a WUSB host and a WUSB docking station and depicts a WUSB request/response sequence for Endpoint Handles, and process steps are shown as horizontal blocks of communications and the steps proceed over time in a downward direction.

FIG. 26 is a two-way communications diagram of a process of communications between a WUSB host and a WUSB docking station and depicts WUSB Host session management in case WUSB connection is disrupted and wherein the WUSB Host sends ping requests, and WUSB dock or device may respond or WUSB session disconnect occurs, and process steps are shown as horizontal blocks of communications and the steps proceed over time in a downward direction.

FIG. 27 is a block diagram of modules and operations in a wireless docking host (WDH) and a wireless dockee, and shows a WDH process embodiment to configure specified WUSB hubs and peripherals.

FIG. 28 is a partially-block, partially-flow diagram of modules and operations in two wireless docking hosts and a wireless dockee, and shows inter-WDH communication and configuration.

FIG. 29 is a block diagram of modules and operations in a wireless docking host (WDH) and a wireless dockee, and shows a process embodiment for WDH WUSB CDC network access to provide a dockee network access through a WDH involving security protocols.

Corresponding numerals in different Figures indicate corresponding parts except where the context indicates otherwise. A minor variation in capitalization or punctuation for the same thing does not necessarily indicate a different thing. A suffix .i or .j refers to any of several numerically suffixed elements having the same prefix.

### DETAILED DESCRIPTION OF EMBODIMENTS

In some of the embodiments, apparatus and methods are provided that sniff or query wireless network-enabled devices to subsequently determine which of the station addresses correspond to known friends. The apparatus and process embodiments automatically make that content accessible to those friends and/or concurrently receive content being sent to the friends so that network bandwidth (e.g., in a Wi-Fi network) is very economically occupied and used. One kind of structure and process embodiment includes one or more MAC (media access control) addresses in file metadata so that a device with this MAC address can subsequently access the file, and another device of a known friend can subsequently access the file as well. This content may be automatically tagged for sharing with devices having specific MAC addresses at creation. In this way, cooperation of multiple devices obviates and replaces competition among devices for time and bandwidth on wireless networks.

Among various embodiments, some of the structures and processes herein automatically index, preview and transfer camera, audio, and other sensor captures and file transfers at one or more stations in a social or networking group of stations communicatively coupled with each other. ('Sensor is given a broad interpretation herein.) Such automatic operations include triggering automatic visibility, access, and remote applications with other stations within this social/networking group. Those stations may or may not be present at capture and/or transfer, and some station embodiments can maintain content and update the friend stations if and when they come into range, or have been powered off and then resume operation powered on. For mobile and battery-powered stations, these automatic operations are supported by hardware that need not impose substantial current drain on the battery or other mobile power supply during such automatic operations. In this way, embodiments support high definition TV, cameras, displays, memory, sensor peripherals, and other types of content transfer modalities in a way that minimizes mobile system power and cost for existing and emerging Wi-Fi use cases such as Wi-Fi Direct or TDLS (Tunneled Direct Link Setup, IEEE 802.11z) social networking and other types of wireless networking. Although wireless networking is used in much of the description by way of a networking example, it is emphasized that various embodiments are suitably also implemented in wired networks whether the networked devices are mobile or not.

A peripheral interface processor integrated circuit embodiment in a mobile device filters and triggers messages that are subsequently shared or visible to other Wi-Fi users within these social/network groups when they are within communicative range. Advantageously, mobile device host processor operation and user interaction are not required, and host processor/DDR/large display power is not consumed. This peripheral interface processor integrated circuit embodiment obviates host compute performance pressures when used with a low-power but low-cost host processor. Such sub-combination embodiments and larger system embodiments are structured for power efficient location applications, file transfer applications, preview applications, and contextually-aware Wi-Fi sensor hub applications that can proceed transparently when the host processor is awake or even when it is sleeping. Not only do the embodiments promote technological economy of networked usage but also they can be miniature in size. Some peripheral interface processor embodiments themselves provide some pins, so pin limitations, such as of a pre-existing mobile device RISC host processor, are no longer consequential even for chips made in advanced integrated circuit fabrication processes like 28 nm and below.

Some embodiments advantageously share contextual information between these subsystems at a low enough level to enable contextual transactions. As an example, the MAC addresses, or GPS location of friends, may be encoded in downloaded files or captured images enabling automated discovery and sharing of these files with previously specified MAC addresses (or locations) without user interaction and without host processor interaction. Such embodiments further promote economy, power efficiency, and satisfying user experience.

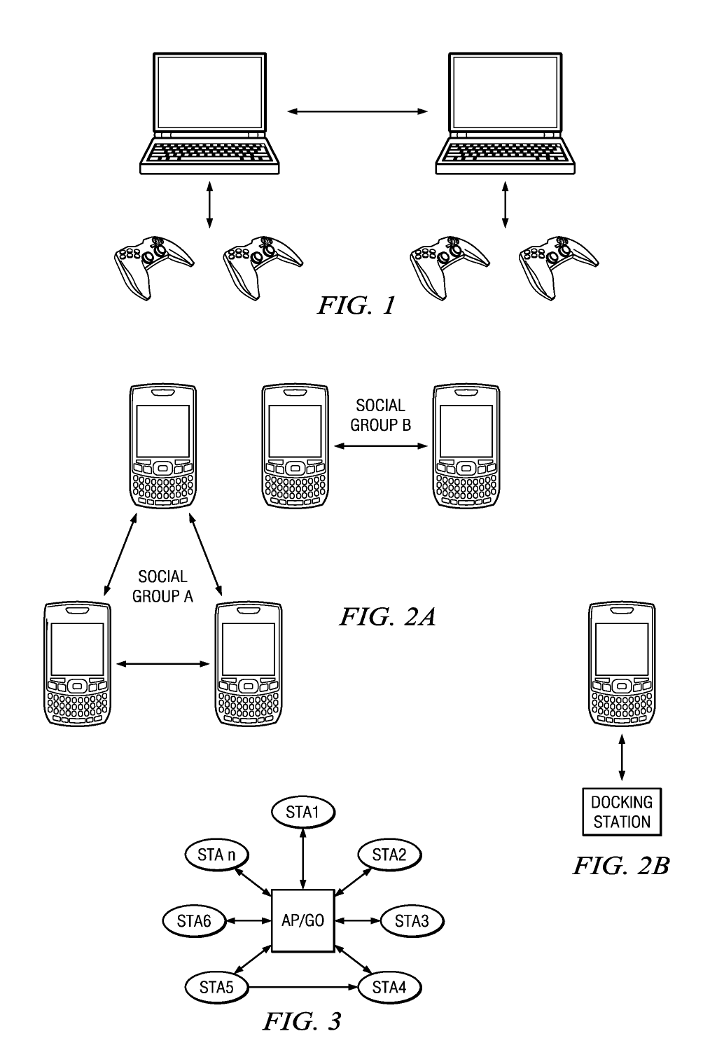

In FIG. 1, consumer electronics device embodiments are wirelessly coupled with one another with low computer burden, low memory usage, and high efficiency and power savings. Laptop computers with wide display screens, digital cameras, gaming controls and any other desired devices are provided to constitute a multi-station wireless system embodiment. Stations can remotely share content, such as a game screen, video clip, work document, or other shared content according to embodiments in the other Figures.

In FIG. 2A, mobile device embodiments in a WLAN wireless network support a social network group A of three friends remotely sharing content among themselves. This WLAN has another social network group B of two friends remotely sharing content between themselves separately from group A. Other examples of such embodiments are further detailed in the other Figures. User interaction and content operations in each social network group A or B are promoted, and information in each social network group (e.g. A) is protected from unintended dispersal into other stations in another social network group (e.g., B) or into some singleton station that is not a member of any group elsewhere in the WLAN.

In FIG. 2B, a mobile device station embodiment communicates wirelessly with a docking station embodiment to share content without physical docking and without tedious user interaction, as detailed in the other Figures. Also, one or more instances of the docking station of FIG. 2B are readily networked with any one or more of the mobile devices in FIG. 2A and configured into the social network group diagrammed in FIG. 2A if appropriate.

A type of social networking is called socially single-mode herein when social network groups are plural but separate, and/or when two groups having at least one member (non-AP) station in common are effectively made into one group operationally. In a socially-multimodal network configuration herein, social network groups may be configured to overlap and nevertheless preserve content for separate groups unless there is affirmative user intervention at a station in the subset of one or more stations where the socially networked groups overlap (i.e. have their membership set intersection). In one form of a socially-multimodal network process, the content suitably has metadata that not only identifies the social group but also its purpose or use category, and the peripheral interface processor automatically handles content according to the intended social group and use category (the social mode herein) as signified by a social group metadata field and a social mode metadata field. In another form of a socially-multimodal network device and process embodiment, a first station device sniffs content going to a second station in a group for which they have membership in common and the first station automatically uses the content only for that group without automatic sharing into any other group of which the first station may also be a member.

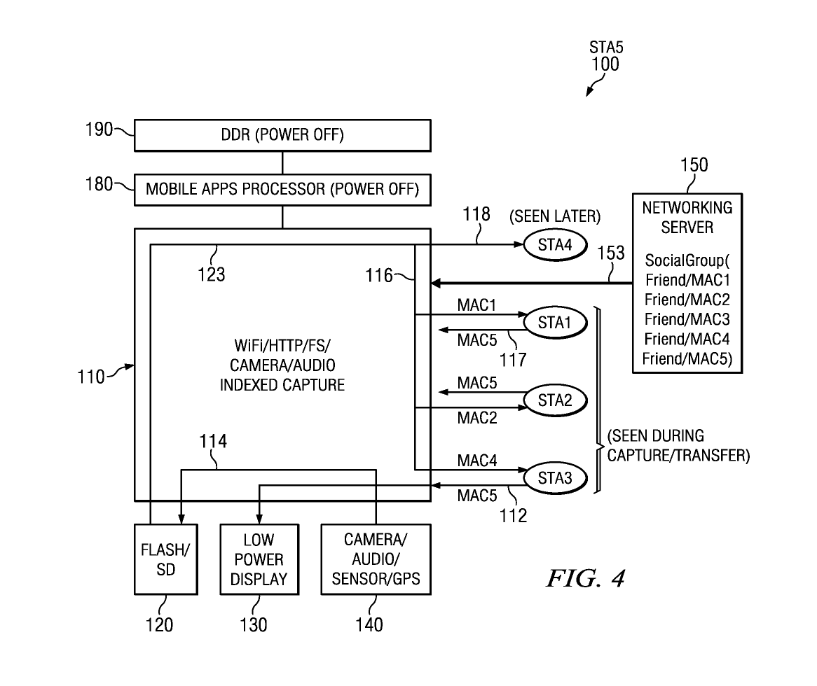

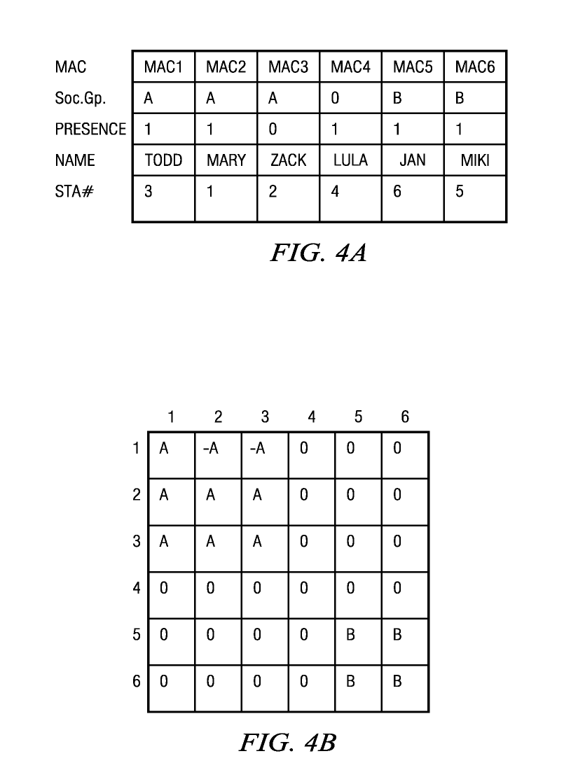

In FIG. 3 and FIG. 4, Wi-Fi Direct network and station embodiments operate as a multi-station wireless system, such as with devices as in FIG. 1, FIG. 2A, and FIG. 2B. Wireless hard-drives, printers, web-cams, cameras, game controllers, content players, televisions, laptop computers, cell phones, internet devices, and other wireless devices are also provided as embodiments for enhanced device to device communication. For some background on some previous work, which is incorporated herein by reference in its entirety, see: U.S. Patent Application Publication 20110188391 “Interrelated Wi-Fi and USB Protocols and Other Application Framework Processes, Circuits and Systems” (TI-69048) dated Aug. 4, 2011; U.S. Patent Application Publication 20110065424 “System and Method to Facilitate Downloading Data at a Mobile Wireless Device” (TI-67861) dated Mar. 17, 2011; U.S. Pat. No. 8,036,703 “Image Capture Reporting Based on Content-Associated Wireless Identification” (TI-39297) dated Oct. 11, 2011; U.S. Patent Application Publication 20050125836 “Shared Wireless Video Downloading” (TI-33714) dated Jun. 9, 2005.

Content discovery technology (such as DLNA compatible) can discover music, video, and pictures in a home network and stream them to any selected destination rendering device with a protocol such as TCP/IP protocol. In FIG. 3 Wi-Fi wireless stations with peer-to-peer (P2P) Wi-Fi Direct connectivity can support such streaming. See STA5 transmitting P2P to STA6 in FIG. 3. The receiving/rendering device such as at STA6 can decode the multimedia format (JPEG, MP3, AVI) and render it on an attached peripheral. Wi-Fi-Direct herein can support virtual attachment for the peripheral as well. FIG. 4 shows a variety of wirelessly connected CE devices, e.g. virtually attached by Wi-Fi Direct—USB and as further improved herein.

TABLE 1 provides a Glossary of some terms used herein and/or as in a published patent application incorporated herein.

TABLE 1
GLOSSARY

| | |
|---|---|
| AP: | Access Point, a Wi-Fi base station |
| Backoff Value: | Collision avoidance support |
| Beacon (TIM): | Traffic Indication Map |
| BSS: | Basic Service Set, a Wi-Fi cell. |
| CDC | Communications device class such as for USB |
| CE: | Consumer Electronics |
| CSMA/CA: | Carrier Sense Multiple Access/Collision Avoidance |
| | used in some WLAN. Station backs off for a time period |
| | if another station is transmitting, then checks again |
| | until clear. |
| CSMA/CS: | Carrier Sense Multiple Access protocol used in Wi-Fi |
| | so each station listens and waits for a clear space |
| | before transmitting. |
| CTS2Self | Clear to Send to Self packet |
| CTWindow: | In 802.11, a period during which Wi-Fi-Direct Client |
| | may transition from Power Save to Active Mode |
| DDR | Double data rate (a type of DRAM) |
| DLNA: | Digital Living Network Alliance |
| DRAM | Dynamic random access memory |
| Doze: | Low power state |
| EAP | Extensible Authentication Protocol |
| EAPOL | EAP over LAN |
| GAS | Generic Advertisement Service |
| Group Owner: | A Wi-Fi-Direct entity assuming the role of an |
| | Access-Point |
| GUI | Graphical User Interface |
| HCCA: | HCF Controlled Channel Access |
| HCF: | Hybrid Coordination Function in IEEE 802.11e for QoS. |
| HDR: | Header |
| LAN | Local Area Network (wired) |
| IP | Internet Protocol |
| LPRF | Low Power RF |
| MAC: | Media Access Controller, media access control |
| MAD: | Medium Access Delay |
| MMC | MultiMediaCard flash memory card |
| PBC | Push-Button Configuration |
| PM = 0/1 | Power Management |
| PS Mode: | Power Save |
| P2P: | Peer-to-Peer |
| QoS: | Quality of Service |
| RF | Radio frequency, wireless |
| RNDIS | Remote Network Driver Interface Specification |
| SD | Service Discovery (in wireless context) |
| SD | Secure Digital (in non-volatile memory card context) |
| SIFS: | Short Interframe Space, time between a data frame |
| | and acknowledgment. |
| SIMD | Single instruction, multiple data processing |
| STA: | Station |
| TBTT: | Target beacon transmission time |
| TCP | Transport Control Protocol |
| TSF: | Timing Synchronization Function transmitted in beacon |
| UPnP | Universal Plug ‘n’ Play |
| USB: | Universal Serial Bus |
| WFA: | Wi-Fi Alliance |
| Wi-Fi: | A type of WLAN defined by IEEE 802.11 standard, |
| | Wi-Fi. |
| WLAN: | Wireless Local Area Network |
| WPS PBC | Wi-Fi Protected Setup Push-Button Configuration |
| WUSB: | Wireless USB |

In FIG. 3, an Access Point (AP) is a WLAN entity that provides access to the system, and one kind of WLAN is specified by the IEEE 802.11 standard, also called Wi-Fi. The AP has a unique 48-bit BSSID, usually the AP MAC Address. A Wi-Fi station STA is any 802.11 compliant wireless device, and it has a physical layer PHY and a media access control MAC and a 48-bit MAC address. A Peer-to-Peer P2P network called Wi-Fi Direct has roles for entities called group owner (GO) and Client that correspond to AP and STA respectively. One WLAN device may take on multiple roles.

A PHY (physical layer) includes the radio transceiver, analog front-end and modem. In the 2.4 GHz band, Wi-Fi currently has 14 fixed 22 MHz-wide channels that can support various data rates depending on the range or distance. The PHY can apply different kinds of modulation to achieve intended data rates. PHY does CCA (Clear Channel Assessment) to determine and administer the use or availability of the wireless channel by energy detection, carrier sensing or both.

In the MAC, MLME (management layer) includes a hand-over mechanism from one AP to another AP, and some management functions. MAC provides security for the connection and data. MAC has a CSMA/CA (Carrier sense Multiple Access with Collision Avoidance) mechanism and can distribute control frames (RTS/CTS) to help protect against or avoid hidden nodes.

MLME controls or manages the below-listed wireless operations. ESSID refers to the ID of an Extended Service Set (ESS), which is a number of interconnected Basic Service Sets (BSSs, each BSS has an AP).
Beacon—Timestamp, Beacon Interval, Capabilities, ESSID, Supported Rates, parameters, Traffic Indication Map (TIM)
Probe Request—ESSID, Capabilities, Supported Rates
Probe Response—Same as Beacon except lacks TIM
Association Request—Capability, Listen Interval, ESSID, Supported Rates
Association Response—Capability, Status Code, Station ID, Supported Rates
Reassociation Request—Capability, Listen Interval, ESSID, Supported Rates, Current AP Address
Reassociation Response—Capability, Status Code, Station ID, Supported Rates
Disassociation—Reason code

Beacon or Probe Response contains information to join a new network. Passive scanning finds networks simply by listening for Beacons. Active scanning on a channel sends a Probe, and then waits for a Probe Response.

A wireless security supplicant module manages secure connection creation on the WLAN. The supplicant initiates scans to obtain candidates for connection and then automatically executes a secure connection sequence to enable secure connection.

In FIG. 4, a system embodiment 100 has a Peripheral I/F Chip or core sub-combination embodiment 110 at a Wi-Fi station STA5. Mobile device host processor 180 operation and user interaction are not required, and power need not be applied to or consumed by host processor 180, DDR SRAM memory 190, nor all of some large display (e.g. in FIG. 1). Peripheral I/F 110 provides itself provides Wi-Fi networking, internet connectivity and World Wide Web browsing with HTTP protocol, and File System FS management with camera/audio/other-content indexed capture. Peripheral I/F 110 has outgoing arrows 116 representing Wi-Fi transmissions to various Wi-Fi mobile stations STA1, STA2, STA3 that are seen (in range) during capture/transfer and an arrow 118 to a station STA4 that is seen later. These Wi-Fi transmissions are used by STA5 to remotely trigger low power display analogous to STA5 display 130 but in each destination station, and/or to remotely trigger audio applications in those stations.

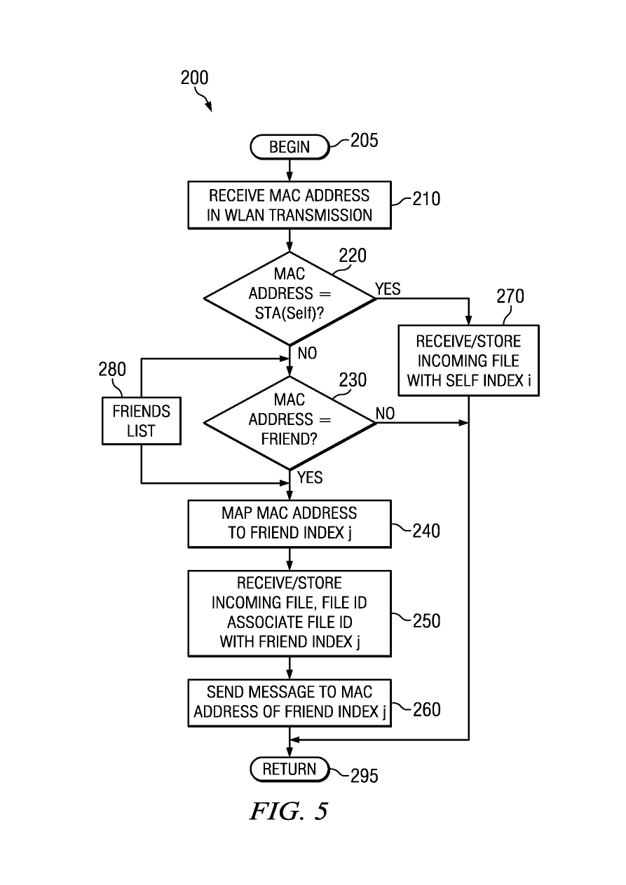

Peripheral I/F 110 operates by an indexed capture process embodiment such as illustrated in FIG. 5 and described later hereinbelow. In FIG. 4, return arrows like 112 and 117 from stations STA1-3 represent MAC message flows that are made visible on the Low Power Display 130 of STA5 itself before or after capture. Such display of new information reception conveniently allows the STA5 user to access the new information if and when the user desires. Firmware or software in a Flash/SD 120 is executed as indicated by arrow 123 to actuate outgoing trigger transmissions from STA5 to trigger low power display and/or audio applications by other stations STA1-4. Content and data in the vicinity of STA5 are acquired by the block Camera/Audio/Sensor/GPS 140 and processed and fed along arrow 114 to the Flash/SD block of STA5 for index-controlled transmissions to stations STA1-4.

In FIG. 4, Station STA5 recognizes that some stations like STA1-5 are listed as friends and some other stations (STA6, etc., not shown) that may be in range at one time or another are not thus listed and therefore are not subject to the automatic communications among friends supported by station STA5. In one form of recordkeeping process embodiment, a social group includes stations that can share information on a completely equal basis. The friends list of STA5 in one form is a suitable set of station IDs in a memory table and accumulated in STA5 by P2P operations and represented by the expression SocialGroup(Friend1/MAC1, Friend2/MAC2, Friend3/MAC3, Friend4/MAC4), or can be stored in the Network Server 150 as illustrated. Various other recordkeeping process embodiments can be provided on a station basis at STA5, such as indexing according to respective ones of social groups such as different school social groups, family social groups such as nuclear family group and extended family groups, work task groups, command-oriented groups, etc. Such a typology can be used for socially-multimodal network process embodiments having networks A, B, C, etc., as in FIG. 2A. In the Network Server 150 an instance of the list for FIG. 4 can be SocialGroupA(Friend1/MAC1, Friend2/MAC2, Friend3/MAC3, Friend4/MAC4, Friend5/MAC5).

Alternatively or additionally, the friends list of STA5 and all other stations STA for which it is desired to keep records are effectively maintained by a Networking Server 150 that keeps records of various such social groups and to which each Wi-Fi AP/GO has ready access. The Networking Server 150 may be local such as for a school campus or for a locality, or for all subscribers of a social networking enterprise, or otherwise extended.

In a mapping storage table of FIG. 4A, the top row has MAC addresses (MAC1, MAC2, etc) of the stations that are accessing, or have accessed, the WLAN. Presence bits (1, 1, 0, etc) indicate whether the station with a given MAC address is currently in the network (e.g. BSS of a local AP). Social group ‘membership’ for each MAC address is tabulated using letter designators ‘A’, ‘B’, etc. The bottom row has Station STA numbers (3, 1, 2, etc) for FIG. 4B for maintaining and addressing a social group storage in FIG. 4B. The STA numbers map to the MAC addresses of the stations and to the Presence bits. Other potentially-useful information about the stations is also recorded in FIG. 4A. Examples of such information are device-specific service or device classes, times when a friend station became absent and then resumed presence, and probable user name.

The times when a friend station became absent and then resumed presence are suitably used by the local station to advise that friend station of available content originated at the local station (or downloaded from outside the social group at the behest of that local station) during the interval of friend station's absence from the network. That way, the friend station is usefully advised so it can pull content if it wishes, but is not flooded with advice messages in the social group from stations that did not originate the content, nor from stations that only pulled or sniffed the content downloaded at the behest of one.

In FIG. 4B, a rectangular storage matrix-based recordkeeping process embodiment recognizes the existence of multiple different social groups as in FIG. 2A. The process can keep track of different social groups, and even their overlapping nature if need be, and helps organize the recordkeeping, e.g., at the Networking Server 150. The electronic storage matrix has addresses allocated to each potential network tie, e.g. using address fields Addr=[i, j]=[STAi, STAj]. The social group matrix is represented by a square storage table having identically-enumerated rows and columns for the individual stations STA. In this illustrated square matrix portion, rows i=1, 2, 3, 4, 5, 6 and columns j=1, 2, 3, 4, 5, 6. Each row i has cells that hold entries that respectively represent whether or not STAi can sniff STAj. Each column j has cells with entries that respectively represent whether or not STAi can be sniffed by STAj. Comparing FIGS. 4A and 2A, the stations numbered STA1, 2, 3 are in social group A. The stations numbered STA5 and STA6 are in social group B. Station STA4 is not in any social group but is present in the WLAN.

For a socially multi-modal matrix of ties, one or more entries in a cell (i, j) for the group membership shared by any two stations i and j can be each social group identifier A, B, etc. representing the groups, and otherwise zero. (Example 1: Stations i and j are both in social group A and no other group. Cell (i, j) has an entry “A”. Multimodal Example 2: Stations j and k are both in social group A and both in social group B and no other group. Cell (j, k) would have a double-entry “A, B” in the cell.)

FIG. 4A represents a process embodiment employing a detailed form of electronic mapping of correspondences in station-related data akin to the functional expression “SocialGroup_( )” in FIG. 4 This data includes MAC addresses that constitute the friends list of FIG. 4A as referred to elsewhere herein. At the Networking Server 150, records in a further form of recordkeeping embodiment illustrated by FIG. 4B are maintained as a triangular array or rectangular matrix of friendship ties. The expression “SocialGroup_( )” of any particular station STAi also is related to the FIG. 4B matrix recordkeeping embodiment involving all the stations STAj for which non-zero entries exist in a row or column of the triangular array or rectangular matrix of social group ties for STAi at the Networking Server 150. In FIG. 4B, the matrix of social groups is related to and/or electronically formed by the matrix multiplication H^{T}H based on the row vector H of group membership. In FIG. 4A, for example, H=[A, A, A, 0, B, B].

Various recordkeeping embodiments can be provided at the Networking Server 150, such as indexing according to social groups at the Networking Server, wherein for a given station a school group matrix is differently constituted to represent a network over the stations than is a family group matrix to represent a different network over the stations. Also, a full square array of ties can be maintained at the Networking Server to represent groups having asymmetric ties. A further form of recordkeeping process embodiment can indicate such asymmetric ties for instance by plus (+) and minus (−) signs. Examples of such ties occur where subordinate stations (e.g., students, work group members) share some information automatically only with peers and a higher or next-higher level station in a hierarchy (e.g., teacher, work group supervisor). A higher or next-higher level station in a hierarchy may in some embodiments “sniff” transmissions to peers and subordinate stations in the network that includes them both but not “sniff” transmissions to superior or super-ordinate (higher-level) stations. (Example 3: Stations i and j are both in social group A, and station j is subordinate to station i. Cell (i, j) has an entry “+A”. Cell (j, i) has an entry “−A”. The entries for other stations are maintained analogously. No tie is represented by zero (0) and its sign is irrelevant.)

A group-member station STA can use a Sniff Off/On command herein to adjust its particular ties in the social group. The data structure of FIG. 4B allows the network server 150 to keep track of such adjustments of ties even though the group memberships represented in FIG. 4A remain unchanged. Since the station is a member of the group, other stations know they can be sniffed, subject to any configured asymmetries in the group structure that remained unchanged in network server storage. Supplemental adjustment entries in the network server storage indicate adjusted tie data. An individual station can forego sniffing capability that is otherwise allowed by sending a Sniff Off command to the network server identifying each station that will not be sniffed. The user of a station may find it useful to forego sniffing in case its user has no interest generally in either the volume or nature of content destined for the other station. Meanwhile, the sniffing ties between stations in the group otherwise remain unchanged. If the user subsequently wants the station to resume sniffing that was turned off, that station sends a Sniff On command to resume that group member privilege. In some embodiments, the network server then sends a confirming message to each of the stations for which the sniff relationship has been changed and telling the nature of the change. Two or more stations STAi and STAj in a group can both turn Sniff Off as to each other without losing their membership in the group. This is represented in FIG. 4B by cell(i,j)=−A and cell(j,i)=−A.

Analogous description can be given for a Push On/Off command except that the destination station gives the command Push Off so that another identified station in the group is then prevented by the destination station from pushing information to the destination station. Since it is a privilege of group membership to receive pushed information, the destination station may waive that privilege by sending the Push Off command or subsequently resumed a privilege by sending a Push On Command. Appropriate bit-fields in the network server 150 storage keep track of the state of adjustments currently in effect with respect to various ties as to Sniff and Push for all the stations in the group. Station-specific information about group membership and adjustments currently in effect is maintained in each station with respect to that station's group-specific ties for Sniff and Push.

Process embodiments for group formation are described later hereinbelow in connection with FIGS. 18-21, to show some ways of constituting a group in the first place.

In FIGS. 5-8, the structural blocks and flows automatically index, preview and transfer content files and sensor 140 captures with a given social networking group. The flow for sensor 140 captures is similar or same as for file capture/transfer since sensor 140 data is stored along flow arrow 114 to a local file in Flash/SD 120 once compressed by processor 110.

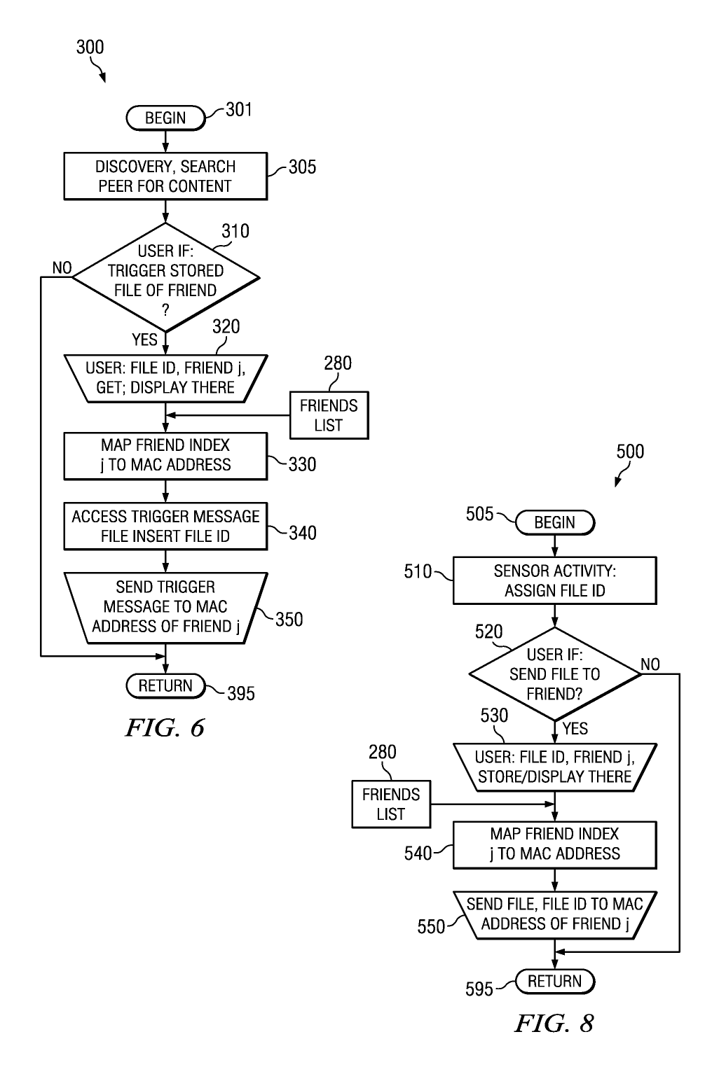

In FIG. 5, the Peripheral interface 110 can receive from the Wi-Fi network through its own Wi-Fi subsystem a different MAC address that represents a different station and a file not originated from the local station, yet destined for that different station. The Peripheral interface 110 checks that different MAC address to see if it is on a Friends list 280. ‘Sniffing’ includes this process of elective or social-group-limited non-addressee station reception herein. This process receives a MAC address that represents a Friend Wi-Fi station and associated content destined for that MAC address sent from a station in the social group and/or from AP. If the received MAC is that of a Friend, the Peripheral interface 110 derives an index from that different MAC address. The Peripheral interface 110 captures that file and associates the index with the file thus captured. Also, the Peripheral interface 110 can send an e-mail or some message to tell the Friend it captured that file destined for the Friend. (‘Sniffing’ of FIG. 5 is distinguished from a related type of operation called ‘peer content searching’ herein that acts as a search process of searching peers in the social group for content of interest as in FIG. 6 step 305. The peer content searching is suitably followed by pulling such content in FIG. 6.)

In FIG. 5, operations commence with a BEGIN 205 and proceed at step 210 to receive a MAC address in a WLAN transmission. In step 210, the peripheral processor 110 executing its firmware can receive from the Wi-Fi network through its own its Wi-Fi subsystem a different MAC address that represents a different station and a file not originated from the local station, yet destined for that different station. A Wi-Fi system as in FIG. 5 has different MAC (media access control) addresses for different stations. A decision step 220 determines whether the received MAC address is the MAC address of the local station device itself. If not, operations proceed to a step 230 in which the peripheral processor 110 checks that different MAC address to see if it is on a Friends list 280, see FIG. 4A. If at step 230, the received MAC address is for a Friend (Yes), the peripheral processor at a step 240 obtains or derives a friend index j from the Friends List 280 to which that different MAC address is mapped. Then in a step 250 the peripheral processor captures that file by receiving and storing the incoming file and its File ID. Step 250 also maps, associates and stores the index j with the File ID of the file thus captured. The peripheral processor at step 260 then sends an e-mail or some message to that MAC address of friend index j to tell the Friend that the local sending device captured that file, whence a RETURN 295 is reached. (The user at the Friend station can configure that station beforehand to view this type of message or to suppress it from view.) In a separate part of the processing operations in FIG. 5, suppose at step 220 that the received MAC address is the MAC address of the local station device itself. In that case, step 220 (Yes) branches to a step 270 that in turn receives and stores an incoming file and its File ID mapped to an index i representing the local station itself. RETURN 295 is thus reached upon completion of either step 260 or 270. Alternatively, suppose that the received MAC address at step 220 is not the local station's own MAC address (220 No) and further at step 230 the received MAC address is not the MAC address of a Friend on friends list 280 either. Then a branch is made from step 230 (No) to bypass the rest of the steps and go straight to RETURN 295 also.

In FIG. 5, the circuitry and process flow detail 200 that does sniffing as shown is supported with and implemented by appropriate firmware. That firmware is suitably coupled with a wireless system software stack in a device embodiment of FIG. 4, 16, 17, or 18. For instance, in some embodiments using Wi-Fi Direct P2P networking, content discovery is contemplated wherein device embodiments are supported by Wi-Fi Direct and operate as taught herein to use and respond to Probe Requests for sniffing purposes. Alternatively, if the device embodiment is a Group Owner as understood in Wi-Fi Direct, the device as Group Owner suitably beacons the information that the devices in the network use to sniff for content. For some background on Wi-Fi Direct P2P networking and wireless USB-like transfers, see U.S. Patent Application Publication 20110188391 “Interrelated Wi-Fi and USB Protocols and Other Application Framework Processes, Circuits and Systems” (TI-69048) dated Aug. 4, 2011, which is incorporated herein by reference in its entirety.

In FIGS. 5-9, the blocks or flow steps filter and trigger automatic visibility, access, messages, and remote applications with other devices/users in the networking group. Such visibility is executed using Wi-Fi Direct discovery, where a device embodiment can respond to Probe Requests, or as a Group Owner GO can beacon with information elements (IEs) indicating GO can provide access to a service with content of interest to another specific Wi-Fi Direct device. Wi-Fi Direct device discovery is remarkably leveraged and augmented herein with special information elements (IEs) indicating friend-specific service or device classes. In this way, what another Wi-Fi Direct STA gets or receives in response to a device discovery probe varies based on its MAC address. The storage table of FIG. 4A facilitates access to such MAC-related data correspondences. Also, any device with a station MAC number can hold a set of information in its own device storage corresponding to a column for its MAC number in FIG. 4A, and the device can use such set of information to respond to a device discovery probe. Wi-Fi Direct service discovery provides an automated supporting mechanism for determining who gets local access to what, to support some of the structure and process embodiments that cause friend-specific service discovery and power management mechanisms herein.

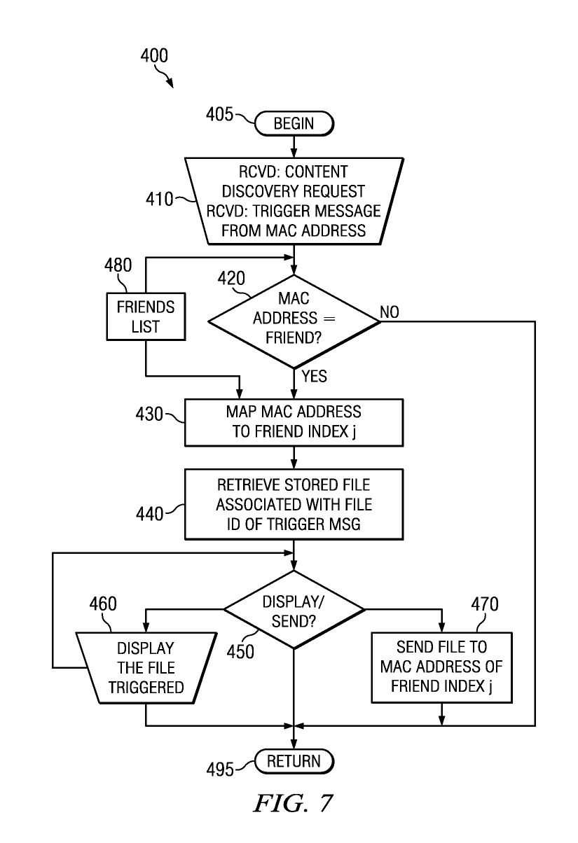

In FIG. 6, operations commence with a BEGIN 301 and in one example of such FIG. 6 process using Wi-Fi, Device1 in a step 305 sends a discovery Probe Request to Device2, which has content that can be used by Device1 through some standard application profile (such as a USB device class: mass storage/camera/etc.) In FIG. 7, Device2 sends a discovery Probe Response that describes both the USB service (such as an available connection for a mass storage application like a file explorer)—and a search result indicator from peer content searching on whether there is shareable content available and/or whether a particular file or type/topic of content file is available. For another example, Device1 sends discovery Probe Request based on FIG. 6 operations. Device2 using FIG. 7 operations sends a Probe Response that it has a USB video class connection. Device2 also indicates and signals that this connection may be used by Device1. Device1 then acquires and uses the USB video class connection too. The searching process for peer content is suitably restricted or limited to electronic members of the same electronic social group. That searching process for peer content is suitably implemented in a module embodiment operating at a Layer or level above, supplementing and in coordination with the probe operations of Wi-Fi Direct.

In FIG. 6, operations respond in a step 310 to a request by user via the local device user interface (e.g. touch-display 130 in FIG. 4) to trigger reception of the stored file of a friend. Upon such request operations go to a step 320 that queries the user (e.g. for a content type, title, and friend name). Using the friends list 280, the local processor of FIG. 4 peripheral interface 110 executes steps 330, 340, 350 that derive information to generate and transmit to the friend as a trigger or “pull” request. Step 330 maps the Friend name to the friend index to the friend's MAC address to which the trigger message will be sent. A step 340 derives a File ID, if that is possible, from the information obtained from the user via the user interface, and otherwise assembles a query as specifically as possible using that information. Step 340 accesses a template or macro in a trigger message file and constructs a trigger message by inserting information such as the File ID itself or the assembled query. Then a step 350 actuates a WLAN-compliant transmission to the MAC address of Friend STAj. RETURN 395 is reached after step 350 or after step 310 (No) if trigger operations are not needed.

In FIG. 7, operations in the Friend Device2 commence with a BEGIN 405 and then a step 410 obtains a received trigger message that has been sent according to the operations of FIG. 6 along with the MAC of the sending Device1. In step 410, the peripheral processor 110 executing its firmware receives from the Wi-Fi network through its own its Wi-Fi subsystem this different MAC address that represents the sending station and determines whether a content discovery request message, or a trigger or “pull request” message is received. A decision step 420 determines whether the received MAC address is on its Friends list 480, see FIG. 4A. If at step 420, the received MAC address is that of a Friend (Yes), the peripheral processor at a step 430 obtains or derives a friend index j from the Friends List 480 to which that MAC address is mapped. Then in a step 440 the peripheral processor retrieves a stored file (e.g. a photo taken earlier by Device2 camera) from local Device2 storage according to requested File ID or query information in the trigger message request.

In FIG. 7, a step 450 asks the Device2 user to indicate and determines whether the Device2 user wants to have the file locally displayed in a step 460 or sent immediately or both in steps 460 and 470, or neither. Local display permits the local user to decide within some configured time period whether to decline to send the file as indicated by arrow from step 460 back to step 450 and by whatever arrow user selects from step 450 directly to step 470 or to RETURN 495. Local display also permits the local user to enjoy the content concurrently with the user of requesting Device1 as indicated by the arrow from step 460 back to step 450 and from step 450 to both of steps 460 and 470 whence RETURN 495 is reached afterwards. Moreover, step 450 can cue the user to permit display in response to the trigger message, and the requester Device1 can insert such request into the trigger message before sending it.

If the Device1 user makes no input either to display or decline, operations go directly from step 450 to step 470. Step 470 assembles and sends a WLAN message including the content file (e.g. photo) to the requesting Device1 of friend index j to tell the requesting Friend that the request is fulfilled, whence a RETURN 495 is reached. (The user at the Friend station can configure that station beforehand to view this type of message or to suppress it from view.) In a separate part of the processing operations in FIG. 7, suppose at step 420 that the received MAC address is not the MAC address of a Friend on friends list 480 or a that the request received in step 410 is a second, dubiously-redundant remotely-originated discovery request including the other MAC address, after the tagged content file locally has first been made remotely discoverable already. Then operations effectually close the content storage against subsequent remote discoverability of the same tagged content file by the same remote station MAC address. Then a branch is made from step 420 (No) to bypass the rest of the steps and go to some other message processing module pertaining to reception of messages from non-friends or go to RETURN 495 directly as shown.

Note that the operations of FIG. 7 can also be combined with those of FIG. 5 by inserting the FIG. 7 operations into box 270 to provide operations specific to trigger messages directed to Device1 there.

In FIGS. 6-7, the Device1 peripheral processor executing its FIG. 6 Device1 firmware can thus request, pull or trigger a Friend STA to execute its FIG. 7 Device2 firmware to send a file and/or remotely display it there. That file may have been created at the Device2 Friend STA and not yet sent, or may have been received or created at the Device2 Friend STA when the Friend was out of range of Device1. Incidentally, such file pull transfers may then automatically be received by other Friends in the same social group. The user at Device1 step 320 enters File ID information, which can be user-relevant information that generally identifies a file or keyword(s), or image cue, or enough information to search for the file. At step 340, the File ID information is converted into a specific File ID number or actual filename either locally if enough information is available to make the conversion, or sent with the trigger message for conversion at the Device2 Friend STA.

In FIG. 8, the Peripheral interface 110 executing its special firmware locally can push and trigger a Friend STA to show a designated image, play audio, or play a video clip to its user. The designated image, audio, or video clip may be either inside the Friend STA, or sent thereto at the command of the local user by the peripheral processor. Operations in a push module 500 commence with a BEGIN 505, and then a step 510 performs sensor activity (e.g., creates an audio file and/or image file) and assigns the content a File ID. A succeeding step 520 electronically asks the user whether it is desired to send the content file to a Friend. If so, the user responds through a user interface (Yes), and operations go to a step 530. Otherwise, an explicit No or lack-of-response at step 520 leads directly to RETURN 595.

At step 530, the user indicates the friend name, and whether it is requested to store-only, display-only, or both at the Friend Device2. Then a step 540 in Device1 accesses friends list 280 and maps the requested friend to MAC address of Device2. A succeeding step 550 constructs the appropriate push-message and sends the File ID and the associated file content to the Device2 MAC address of that Friend, whence RETURN 595 is reached.

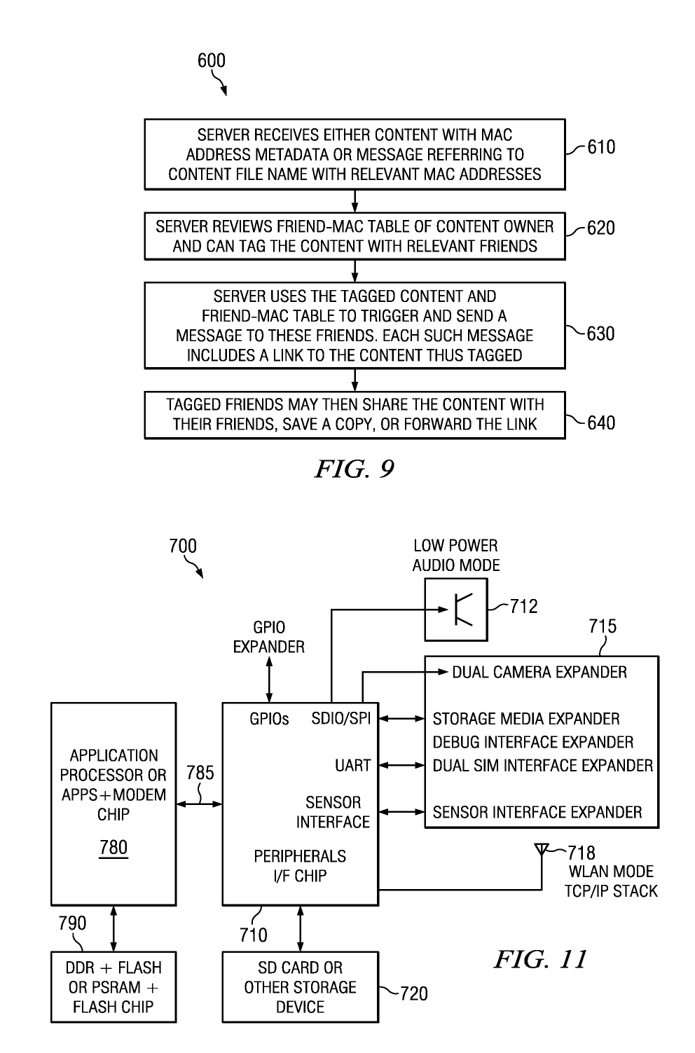

In FIG. 8 or 9, the Peripheral interface 110 executing its special firmware locally can push, or trigger a Friend STA to show a designated image, play audio, or play a video clip to its own user. The designated image, audio, or video clip may be either inside the Friend STA, or sent thereto at the command of the local user's Peripheral interface 110. In FIG. 8 or 9, a flow for this push process embodiment establishes a social networking website folder beforehand, and then particular content is automatically pushed to a friend, e.g. immediately if high priority, or at a low-traffic period such as late at night for low priority content sharing. For example, suppose the user has captured an image of a friend and discovered via Wi-Fi Direct device discovery that the user was present when the picture was taken. User has uploaded this picture to a social networking website. Also, in the file metadata, user has stored the MAC address of this friend. The friend can already see the photo through social networking website, but since user was there the social networking website tags user as being in the photo and alerts user's own friends about this photo. The social networking website automatically sends a message to user's friends via email letting them know user was tagged. (It is believed that hitherto friends have had to manually tag the user upon seeing user in a photo.)

In FIG. 9, the Server 150 operates according to another process embodiment 600. Server 150 receives and stores data representing and identifying the APs to which each of many handsets or mobile devices are talking or otherwise communicating. Such server 150 may be a social networking website server or generic content sharing server or an access point AP. In one such server process embodiment 600:

1. Server at a step 610 receives either content with MAC address metadata or message referring to content file name with relevant MAC addresses.
2. Server reviews Friend-MAC table of content owner at a step 620 and tags the content with relevant friends.
3. Server at a step 630 uses the tagged content and Friend-MAC table of FIG. 4A to trigger and send a message to these Friends. Each such message includes a link to the content thus tagged.
4. Tagged friends may then share the content with their friends, save a copy, or forward the link in a step 640.

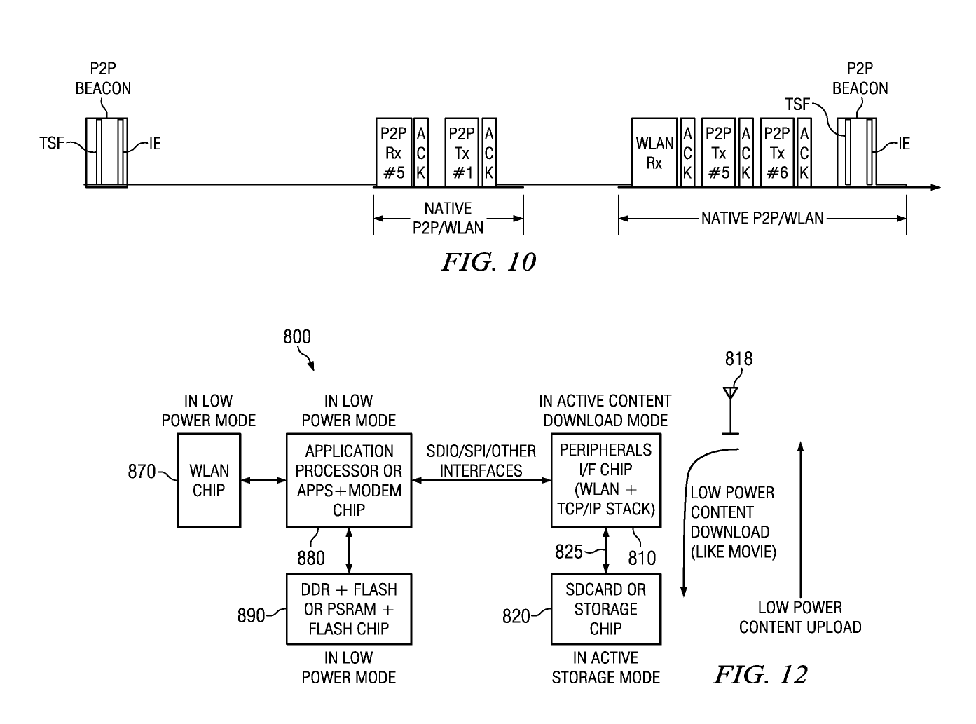

Wide-area network WAN P2P and wireless local area network WLAN P2P are believed well-suited for wide application in feature phones because they can enable long range free-to-user applications. In some embodiments, WLAN Mode is coupled with a TCP/IP Stack on an integrated circuit or SoC core type of embodiment for WLAN enablement on even inexpensive RISC processor-based low-end applications. FIGS. 3 and 10 and other Figures help describe Wi-Fi Direct for P2P use in some embodiments.

Feature phones face issue of limited pins, low cost pressures and being based out of mostly low power but low-cost RISC processors, to which Wi-Fi traffic can add computer burden, along with normal host and time sensitive applications. Some application embodiments can include external pin and interface expander chips and discrete components. Support for dual camera or dual mini-display is suitably provided on low end 3G chips. A Peripheral I/F Chip embodiment and system embodiment as variously shown in any of FIGS. 11-17 economically solve problems of limited pins, power conservation, performance, and provide an external sensor hub that accommodates multiple sensors integrated for better human user interaction.

In FIG. 10, a Wi-Fi Direct protocol supports peer-to-peer P2P operations and intelligent power management. Wi-Fi Direct protocol has beacon signals separated by intervals called beacon periods. Further background on WiFi (IEEE 802.11), USB 2.0, WUSB (or wireless USB), and WiFi Direct, is found in:

1) IEEE Standard for Information technology—Telecommunications and information exchange between systems—Local and metropolitan area networks—Specific requirements, Part 11: Wireless LAN Medium Access Control (MAC) and Physical Layer (PHY) Specifications. IEEE Std 802.11™-2007. http://standards.ieee.org/getieee802/download/802.11-2007.pdf

2) Universal Serial Bus Specification (Revision 2.0), Apr. 27, 2000. http://www.usb.org/home

3) Wireless USB Specification Rev. 1.1, Sep. 9, 2010. (WUSB spec) http://www.usb.org/developers/wusb/docs/4)

4) Wi-Fi Peer-to-Peer (P2P) Technical Specification: Version 1.1. Wi-Fi Alliance Technical Committee, P2P Task Group. Wi-Fi Alliance, 2010. http://www.wi-fi.org/Wi-Fi Direct.php and https://www.wi-fi.org/knowledge-center/published-specifications

For embodiments using Wi-Fi support, service information for the embodiment is suitably put on the Wi-Fi beacon. Service information includes USB device class and subclass information elements (IEs) specified by USBIF (USB interface) at http://www.usb.org/developers/defined class and see also TABLE 2. Wi-Fi Direct operations include intelligent power savings and P2P link management between peers. Wi-Fi Direct supports peer applications well, like gaming and fast synchronization information between handsets or other mobile devices. Wi-Fi has a CSMA/CS network protocol that involves medium arbitration and backoffs. For some background on Wi-Fi Direct P2P networking and wireless USB-like transfers, see U.S. Patent Application Publication 20110188391 “Interrelated Wi-Fi and USB Protocols and Other Application Framework Processes, Circuits and Systems” (TI-69048) dated Aug. 4, 2011, which is incorporated herein by reference in its entirety. Interoperability with CSMA/CA-based Wi-Fi devices can be done by: 1) CTS2Self, 2) HCCA, 3) Separate channels. Concurrent operation is enabled concurrent Wi-Fi-Direct and Wi-Fi stations STA. Bursting activity is also supported in Wi-Fi Direct, which is deployed for USB wirelessly. Timing is based on FIG. 3 AP/GO's TSF (Timing Synchronization Function) transmitted in the beacon of FIG. 10. TSF resolution is 1 usec (one microsecond). Burst Mode uses WLAN's Block Acknowledge ACK (with Immediate policy) to allow multiple data packets per data phase, which improves efficiency of transaction.

P2P Device Discovery uses P2P's Probe-Request and Probe-Response frames as discussed later herein in FIGS. 22-26 and in the Wi-Fi Direct spec. The P2P Client has an Interface Address. The device also uses P2P Group Formation and uses P2P GO Negotiation for Master/Slave negotiation. P2P Service Discovery is used to identify the capabilities of a P2P device as a wireless USB device. A P2P Invitation Procedure is provided.

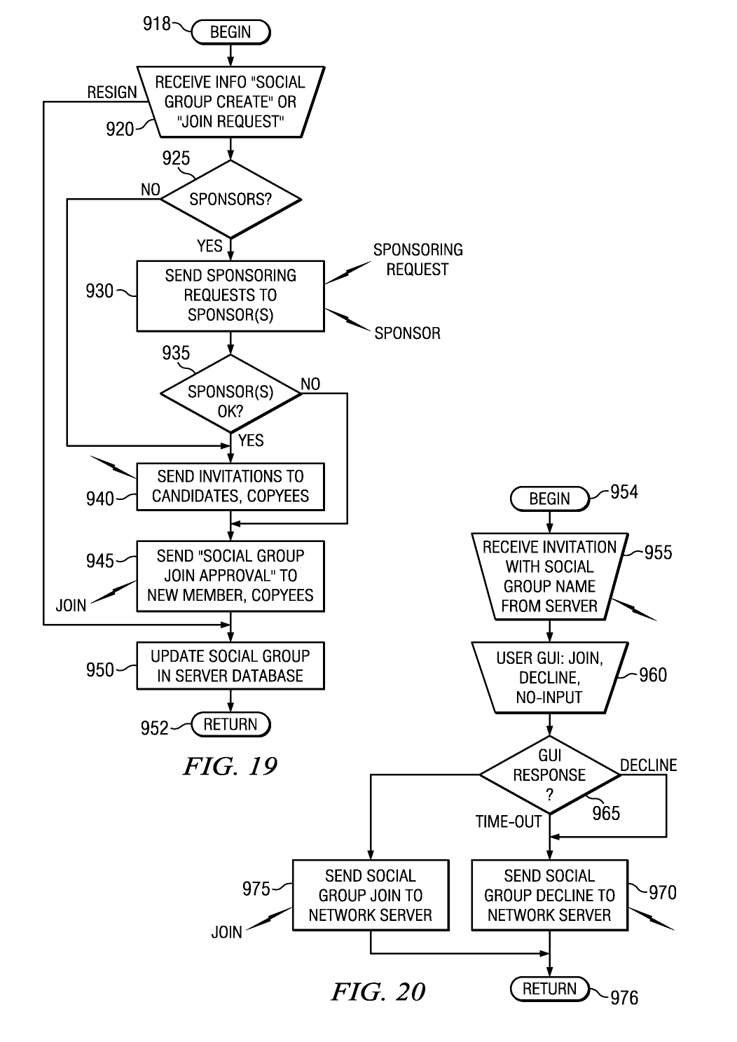

Interoperability of embodiments with WLAN Infrastructure networks leverages on P2P Managed Devices and allows the infrastructure AP (WLAN access point) to control the operational parameters of the P2P network. Such control process is suitably used by the skilled worker (say, in an IT information technology department of an organization) to optimize P2P Devices within the IT defined channel mappings assigned to IT controlled APs. The process controls the operating channel of the P2P network (including channel switch) and controls maximum transmit power. At a higher level herein the AP/GO or Network Server 150 operating through AP/GO can additionally administer social groups of FIGS. 1-4B as in FIG. 19.

Some attributes of the physical layer PHY are: 2.4 GHz (3 channels) & 5 GHz (10+ channels), under the IEEE 802.11n standard for instance. 40 MHz SISO (single-input, single-output) and 2×2 20 MHz MIMO (multiple-input, multiple-output) (˜150 Mbps) is a baseline for the PHY, and 2×2 40 MHz MIMO (300 Mbps), and higher MIMO are optional for higher rates.

Wi-Fi Direct offers enhanced Power Management. One power management process embodiment is a P2P Group Owner Opportunistic Power Save Procedure. Another power management process embodiment is a P2P Group Owner Notice of Absence Procedure.

Removal of the Wi-Fi Direct STA is based on Disconnecting P2P Device. P2P security for communication within a P2P Group employs e.g., WPA2-Personal security.

In FIGS. 4, 5, and 10, the peripheral interface automatically recognizes the presence of that service information from the Wi-Fi beacon being received. Then the receiver extracts that service information from the beacon similar to the way Wi-Fi Display currently works. A USB (or WUSB) device type is followed by information elements (IEs) of FIG. 10 corresponding to USB device classes and subclasses. This process is detailed later hereinbelow in connection with TABLE 1, TABLE 2, and FIG. 22. The receiver embodiment prompts the user such as with an icon showing the available service along with a picture of the person that is remotely offering it to the local user of the receiver. The local user can click on this icon to trigger the connection and launch the app that uses this service.

In various wireless system embodiments, discovery can operate over various channels. For the particular example of Wi-Fi Direct infrastructure, device discovery is suitably conveyed on 2.4 GHz channels 1, 6, and 11 per the Wi-Fi Direct specification. Some embodiments employ multiple rates and bandwidths for discovery to sniff as in FIG. 5, i.e. listen in on, a larger or smaller subset of Wi-Fi channels.

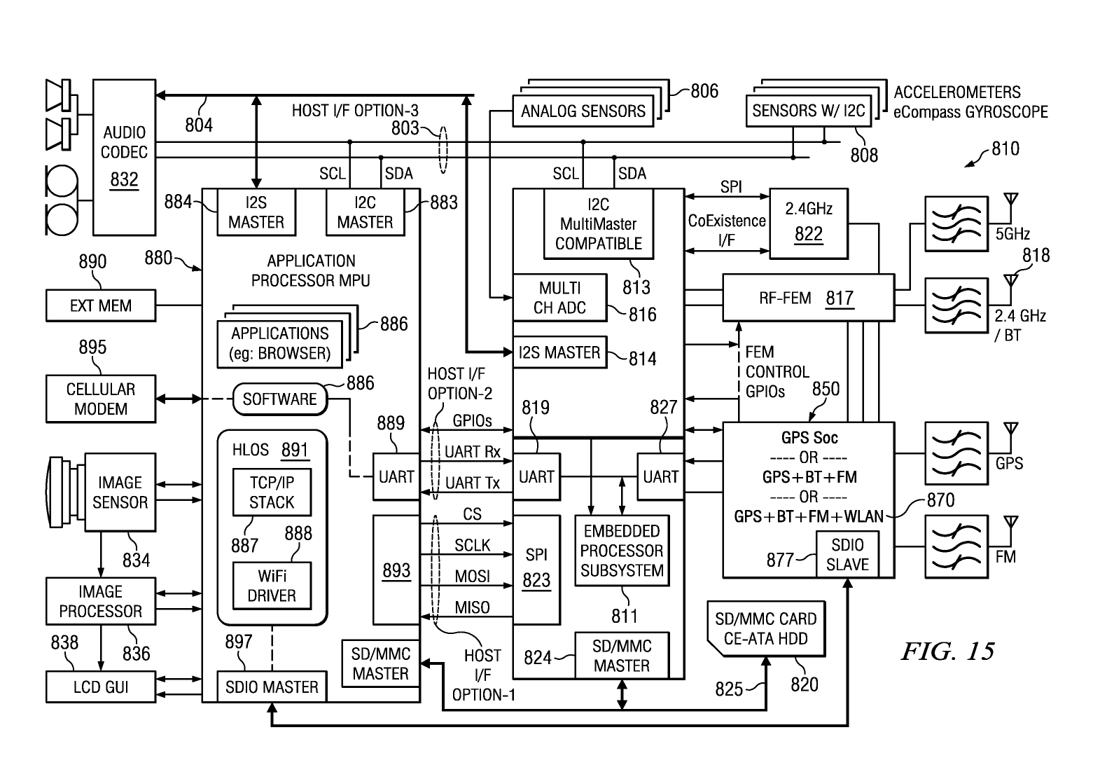

In FIG. 11, a system embodiment 700 caters to, accommodates, resolves or overcomes performance, power and pin constraints while additionally conferring FIG. 10 P2P WLAN functionality via antenna 718 and social group P2P operations as in FIGS. 6-9 at very low cost and not loading an associated host application processor 780. A manufacturer can add performance to existing device products and thereby extend useful product life of some existing component chips such as application processor 780 and a flash memory 790. An available TCP/IP (Internet protocol) stack efficiently runs on a peripheral interface chip embodiment 710 such as is detailed in FIGS. 15-17.

In FIG. 11, peripheral interface 710 is coupled to a low-power audio output circuit 712 with an audible transducer for user. Peripheral interface 710 overcomes pin limitations and readily accommodates various expander circuits 715, such as a dual camera expander, a storage media expander, a debug interface expander, a dual SIM interface expander, GPIO expander, and a sensor interface expander.

In FIG. 11, peripheral interface 710 is factory programmed (ROM plus initial flash code) either by chip manufacturer for a certain configuration, or a device manufacturer (OEM) can also burn own application-specific code into flash for peripheral interface 710 via a UART loader. A UART (universal asynchronous receiver/transmitter circuit) performs the conversion of data between parallel and serial lines. At run time, a host interface 785 is used to exchange command/response/data/configuration/patch code with the external host processor 780 via any suitable interface such as SPI, UART, I2C, SDIO, etc. The hardware of peripheral interface embodiment 710 is made very flexible to allow application-specific configurations for resident FW (firmware) code (flash/ROM) to use, interpret and effectuate.

In FIG. 11, a peripheral interface 710 and other circuits in the mobile device 700 interact as various ones of the circuits such as 780, 790 go to sleep and wake up. Processor chip 780 can be an application processor such as an OMAP™ processor from Texas Instruments Inc., Dallas, Tex., or some other processor. Another form of processor chip 780 has a combined applications (APPS) processor core plus an associated modem core or chip. Storage chip 790 in one form is a combination of DDR DRAM and flash memory, and in another form is a combination of PSRAM (programmable static random access memory) plus flash. For host 780-integrated versions, the radio (wireless radio in peripheral I/F 710 or a pre-existing radio 870 as in FIG. 12) suitably goes to sleep when there is no data to send or anticipated to be received. The radio periodically executes wakeup and checks the beacon TIM to see if something was sent. The host processor 780 also goes to sleep, and it executes wakeup, e.g. in response to an interrupt or otherwise when it sees or detects that some other station has sent it a message on the network to which it is connected.

In an unassociated case, i.e. not-yet P2P-connected to the wireless network, each Wi-Fi Direct device STAi in FIG. 3 periodically executes a wakeup and listens for 100 ms on e.g. Channels 1, 6, and 11 to see if there is an information element (IE in FIG. 10) in a beacon for a service class of interest, see e.g. TABLE 2. If so, availability of content/service for that device 700 is subsequently probed-for, so the beaconing device (AP/GO) can know both the applicable device 700 MAC address and social group device MAC address that has available content/service.

In FIG. 12, a battery-driven device embodiment 800 is arranged as a cell phone, netbook, notebook, or other device with pads, and supports a very low power, large content download and/or upload, such as for transferring movies or video/audio clips, using such Peripheral I/F Chip 810 embodiment. Host processor 880 and a pre-existing WLAN chip 870 and a storage chip 890 can all be sleeping. This operation is called a Low Power Transfer mode herein. Low Power Transfer mode can operate as a receive mode (down arrow) called Low-Power Content Download herein or as a transmit mode (up-arrow) called Low-Power Download Upload herein.

In FIG. 12, chips 870, 880 and 890 are power-managed so that they can at least sometimes be powered to lower power. Peripheral I/F chip 810 and an SD card or storage chip 820 are active for P2P content transfers by Low-Power Content Download or Low-Power Content Upload from time to time when needed, and can otherwise be powered to even lower power as well. For example, Peripheral I/F chip 810 can operate for Low-Power Content Download (such as to transfer in a movie, a still photograph, some audio, or a data file) so that signals received at antenna 818 suitably processed and passed along a bus 825 and stored in high-capacity storage 820. The content download can be the result of a sniffing process as in FIG. 5, a pull process as in FIGS. 6 and 7, or a remotely-initiated push process from another station as in FIG. 8. Peripheral I/F chip 810 can operate for Low-Power Content Upload by operating Peripheral I/F chip 810 to access content from high-capacity storage 820 along this 825. Peripheral I/F chip 810 encodes the thereby-accessed content such as movie, a still photograph, some audio, or a data file, etc., and sends transmitter signals to antenna 818 to transfer or share such content. The Low-Power Content Upload can be a response to a remotely-initiated pull process as in FIGS. 6 and 7, or a locally-initiated push process from the device 800 as in FIG. 8.

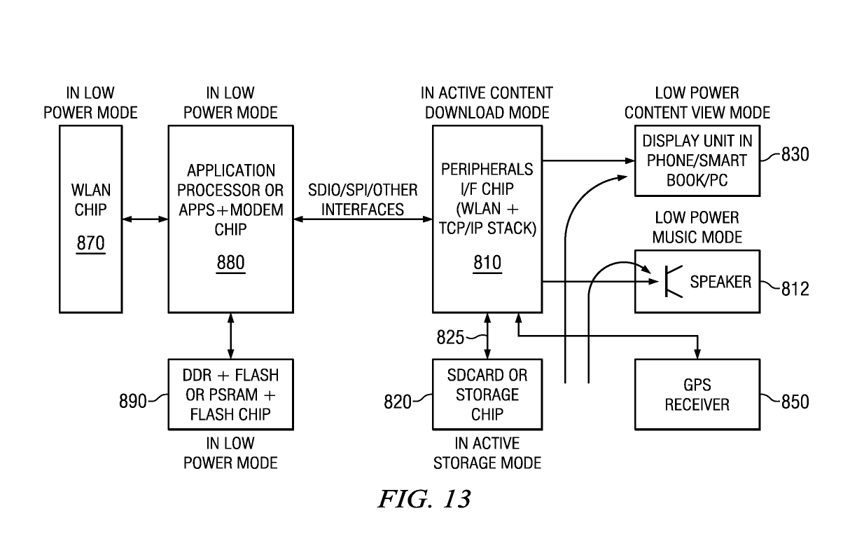

In FIG. 13, low power audio circuit 812 and mini-display unit 830 are coupled by the Peripheral I/F Chip embodiment 810 and system embodiment. This operation is called a Low Power Preview or Low Power Content View mode herein. Peripheral I/F chip 810 can operate for Low-Power Preview or Low Power Content View by operating to access content from high-capacity storage 820 along bus 825. Peripheral I/F chip 810 decodes, renders or otherwise processes the thereby-accessed content such as movie, a still photograph, some audio, or a data file, etc., and delivers the content to the low power audio circuit 812 and/or mini-display unit 830. Such mode can be initiated locally in device 800 to view sniffed content or otherwise-received content from Low-Power Content Download. Such view mode can also be initiated remotely such as by pull-related step 450 in FIG. 7 or push-related step 530 in FIG. 8. A battery-driven device embodiment like a phone, handset, netbook, notebook and pads thus supports a very low power audio playback and mini-display, shared display, or secondary display using such Peripheral I/F Chip 810. Concurrently it can support some peer to peer (P2P) Wi-Fi applications without waking up the host 880.

In FIG. 13, a secondary display is any suitably smaller, low-power display, e.g. a lower-resolution LCD w/SPI interface such as is familiar and provided on the flap of clamshell phones. Such SPI LCD display is connected to the peripheral interface controller 110. The user experience is enhanced by conveying messages or static images to the secondary display like: “Buddy xyz Found!”, “Up/Dn Load in progress . . . 63% Done”, “A file is being pushed/pulled by xyz”, “Current Indoor GPS location: xyz”, etc. Peripheral I/F Chip 810 is desirably made audio capable to deliver voice-based announcements of these events as well. See the audio path in FIG. 13. During such announcements, peripheral interface 110 in one type of embodiment sends a request to host 880, so that host 880 grants the request by tri-state host I2S driver IOs to avoid audio contention.

In FIG. 13, a battery-driven device embodiment like a cell phone, IP phone, netbook, notebook and pads can support a GPS receiver 850 operated in a very low power GPS mode using such Peripheral I/F Chip 810. This operation is called a Low Power Location mode or Low Power GPS mode herein. Host 880 can be sleeping. Also, such Peripheral I/F Chip 810 can directly talk to or communicate with a connectivity combo device with GPS.

In combination with the GPS receiver 850, and video display or LCD, the peripheral interface 810 and processor 880 support location-based embodiments and services of various types, such as roadmaps and directions thereon to a destination, pictorials of nearby commercial establishments, offices, and residences of friends, various family supervision applications, position sending to friends or to emergency E911 service, and other location based services now known or yet to be devised.

For WLAN, a core associated with peripheral interface 810 includes MAC (media access controller), PHY (physical layer), and AFE (analog front end) for use in various WLAN and UMA (Unlicensed Mobile Access) modem applications. In some embodiments, GPS receiver 850 operates in close coordination with any one, some, or all of WLAN, WiMax, DVB, or other network, to provide positioning, position-based, and user real-time kinematics applications. Still other additional wireless interfaces such as for wideband wireless such as IEEE 802.16 WiMAX mesh networking and other standards are suitably provided and coupled to the peripheral interface 810 and other processor(s) 880 in the system. WiMax has MAC and PHY processes and a WiMax AFE.

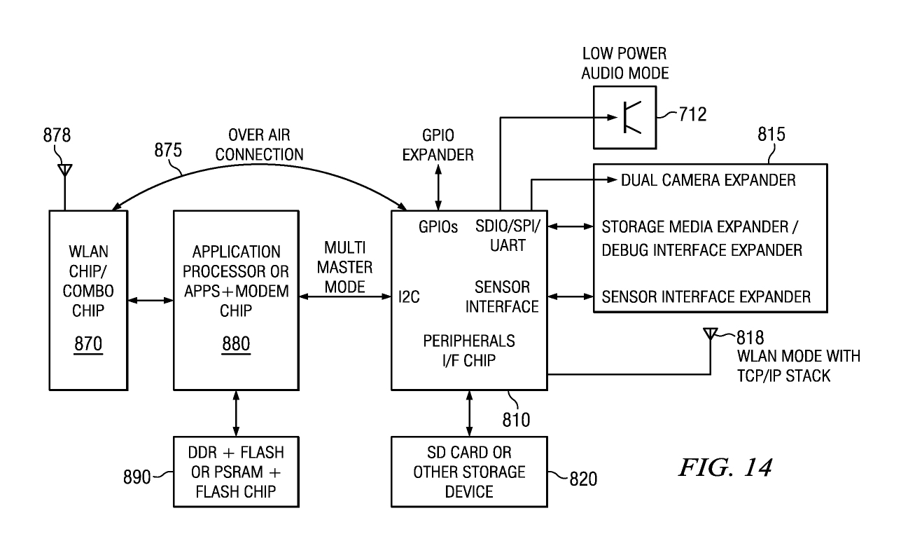

A problem of reduced pins in high-end pin-limited chips 880, is posed by small, inexpensive integrated circuit die made in advanced integrated circuit fabrication processes like 28 nm and below, while needing to support many complex and concurrent applications and sensor interfaces. In FIG. 14, a configuration of Peripheral I/F Chip embodiment 810 operating along with WLAN chip 870 in a short range low power mode for transmissions 875 between them further reduces the pin-out that would otherwise be employed for a combined SoC. Multiple instances of WLAN and increased numbers of antennas are contemplated in some embodiments, which can involve two-or-more WLAN co-existence and increased number of antennas (MIMO). In some embodiments, the WLAN chip 870 and the WLAN core in the Peripheral Interface chip 810 instead or additionally cooperate (MIMO) to transmit simultaneously from two antennas 818 and 878 and to receive simultaneously from the two antennas 818 and 878.

In FIG. 14, a real-time GPIO handshake herein solves a problem of 2-WLAN coexistence. Notice that in FIGS. 12-14, both WLAN chip 870 and Peripheral I/F 810 can support WLAN station functions and have their own MAC addresses. In one type of embodiment, host 880 sees the peripheral interface 810 as a multifunction memory card, and host 880 acts as a bridge master. The signaling uses a semaphore and muxing mechanism with two WLAN MACs where the same radio 870 (or wireline modem if in a LAN) is shared between two MACs. One MAC tells the AP or GO it is connected to that it was or will be taking a nap while or whereupon the other MAC uses the radio. The semaphore suitably is signaled in hardware, e.g. via GPIO as a high-active signal or low-active signal. Some other embodiments can implement the signaling process in software through a suitable communication channel.

With the real-time GPIO handshake for 2-WLAN coexistence, the regular WLAN 870 is connected via SDIO (serial data input/output) slave 877 to main processor/host 880 SDIO master 897. As part of the HLOS 891 software build, Host 880 runs a Wi-Fi driver 888 and network stack 887 for apps like browser 886, etc. In embodiments having two local WLAN cores, when both WLANs are using the same band (2.4/5 GHz), peripheral interface 810 waits until the main WLAN 870 is disabled by the host 880 software before peripheral interface 810 transmits in bulk, such as a content file transfer sent out of antenna 818. For shorter or more urgent transmissions, such as to maintain connection to FIG. 3 AP/GO, peripheral interface 810 can use an existing BT-WLAN co-existence interface e.g. with e.g. four (4) GPIOs to request WLAN 870 to relinquish the medium.

In FIG. 15, another type of embodiment has peripheral interface 810 but host 880 does not treat interface 810 as if it were a multifunctional memory card. Instead, in FIG. 15, peripheral interface 810 hooks or is coupled in parallel via an SD/MMC master 824 to an existing memory card bus (SD or MMC) 825. Additional connection to host, e.g. application processor 880, is accomplished by hooking a multi-master master/slave I2C interface 813 included in peripheral interface 810 to one or more of the I2C buses 803 in the mobile device 800. A Host 880 that has an available SPI (serial peripheral interface) 893 or an available UART (parallel-to-serial Universal Asynchronous Receiver Transmitter) 889 can use either such interface for the connection instead. Peripheral interface 810 has a UART 819 and an SPI interface 823 coupled to host UART 889 and host SPI interface 983, respectively. The traffic for configuration/control involves a low data rate, so even the slower I2C is sufficient, e.g. using path 883, 803, 813 or path 884, 804, 814.

Application processor 880 sends commands to peripheral processor 810 by any such suitable path. The commands include a command communicating availability of SD/MMC bus 825. An UPLOAD command directs peripheral processor 810 to upload content. The Upload command specifies which files to upload, and to which destination(s). The destination IP address, socket, port, and authentication details can be preloaded into a programmable nonvolatile memory space in a SoC including peripheral processor 810.

Using any of SPI (host option #1), UART(host option #2), I2C (host option #3), or other suitable interface or combination of such interfaces, host 880 signals Peripheral Interface 810 with the BUS Avail command that host 880 has tri-stated its SD/MMC Master IOs (ie. now in high-impedance state). Host 880 may also give an UPLOAD command or alternatively may leave Peripheral Interface 810 to handle whatever network traffic may bring it or whatever operations it may independently do for user. With the SD/MMC bus 825 available and host SD/MMC Master I/Os tri-stated, only Peripheral Interface 810 accesses the storage media 820 whereby contention is avoided with host. Host 880 subsequently notifies Peripheral Interface 810 with a BUS_VAC command to vacate the card bus SD/MMC 825 before host 880 accesses the storage media 820 on that card bus 825 again. Contention for bus 825 is thus prevented by software coordinated access so that whichever Master is inactive (host 880 or peripheral interface 810) remains high-impedance (Hi-Z) at least as long as the other Master is active.

In FIGS. 15-17, an example of hardware/firmware for a peripheral interface 710 (810) of FIG. 11-14 provides a single chip 802.11(a) bgn power optimized WLAN solution with integrated MAC, PHY, AFE (analog front end) or Radio, and RF PA (power amplifier). An RF FEM (front-end module) 819 includes one or more of the following: 1) antenna switch, 2) transmit/receive switch, 3) the RF PA (power amplifier). WLAN firmware on-chip 810 is associated with a WLAN driver and a complete network stack, including TCP/IP. The network stack and any application code are executed on an integrated microprocessor MPU 880 or microcontroller MCU subsystem. One type of core is an ARM™ Cortex™ M4 such as compatible with a Stellaris® MCU core. A Texas Instruments Stellaris® MCU platform includes an MCU sub-system 880 and can have peripherals with ultra low power capabilities including one or more modules timed to activate after a predetermined time period of inactivation. A WLAN core is integrated into the MCU platform in some embodiments to form the peripheral interface 810 on an integrated circuit die. The on-chip driver and network stack may be bypassed for some applications that may use a Host-based TCP/IP stack and driver. Protocol and RF coexistence is provided to low power radio frequency cores or chips for ZigBee, ANT, BLE, and BAN (body area network), see 2.4 GHz core 822 coupled via SPI and by a coexistence interface of core 810. Using an integrated, secure network stack (e.g., IPv6), large externally-programmable flash memory 820 and advanced power management, embedded and even deeply embedded system embodiments connect with local networks and internet and WLAN infrastructure. The flash memory 820 is stacked by wire bonding on top of a bottom die for peripheral interface 810 using die-to-die IOs. The term “deeply embedded” refers to e.g. sensor connectivity applications that employ microcontrollers. “Embedded” connectivity applications generally have a more expensive applications processor 880, typically with an MMU running an HLOS 891 for example in cameras 834 and media players such as using audio codec 832 and LCD 838.

Peripheral Interface 810 performs functions including data processing 811, sensor hub, and Wi-Fi 870 or controls for it, which can be integrated as a low power core in the same integrated circuit/chip 810. Sensors 808 include accelerometers, e-compass, gyroscope, and any other appropriate sensors for facilitating positioning. Any analog sensors 806, 808 are suitably coupled to a multi-channel ADC (analog to digital converter) 816 either by coupling to core 810 or internally therein. Peripheral Interface 810 is coupled to the sensors 808 in any suitable manner such as by I2C 803, 813, and performs additional positioning-related processing of sensor measurements and Wi-Fi data and/or other data. Among other processing, blending of data from GPS 850 plus sensors 808, plus Wi-Fi, and/or additional positioning processes are suitably implemented by Peripheral Interface 810. Additional processes represented by software are suitably deployed wirelessly as OTA upgrades (over the air). Bluetooth BT short distance radio and an FM radio receiver are integrated with GPS core/chip 850 if desired.

Any of the WLAN, BT, FM, GPS, etc, radios 850, 870 are suitably coupled via GPIOs and/or another UART 827 in and to Peripheral Interface 810. UARTs 819 and 827 are coupled to each other and to embedded processor subsystem 811 of Peripheral Interface 810. The GPIOs are also coupled to each other and to embedded processor subsystem 811 of Peripheral Interface 810, as well as to GPIO interfaces of the radios 850, 870, and to host 880. Embedded processor subsystem 811 has access via coupling lines to all of the interfaces 813, 814, 816, 819, 823, 824, 827, and some of those lines are omitted for conciseness of illustration. Peripheral interface 810 has ample connectivity to connect to user inputs as well, such as to an optical mouse by I2C or SPI, and to a basic mobile device matrix keyboard such as by GPIO.

Host MPU 880 has applications software for supporting an audio codec 832, an image sensor 834, an LCD display 838 and a cellular modem 895. An additional image coprocessor core/chip 836 may also be coupled with image sensor 834 and host MPU 880. Part of the host 880 application software 886 obtains GPS assistance (AGPS) information from a cellular modem 895 and injects AGPS via UART interface 889 to Peripheral I/F 810. The UART interface 889 is also used for configuring Peripheral I/F 810 and for receiving position information such as from position information blending processes executed by Peripheral I/F 810.

Cellular modem 895 in various forms can support and provide wireless modem interfaces for any one or more of GSM, GPRS, EDGE, UMTS, and OFDMA/MIMO (Global System for Mobile communications, General Packet Radio Service, Enhanced Data Rates for Global Evolution, Universal Mobile Telecommunications System, Orthogonal Frequency Division Multiple Access and Multiple Input Multiple Output Antennas) wireless, with or without high speed digital data service. Cellular modem 895 suitably provides codec for CDMA (Code Division Multiple Access), CDMA2000, and/or WCDMA (wideband CDMA or UMTS) wireless suitably with HSDPA/HSUPA (High Speed Downlink Packet Access, High Speed Uplink Packet Access) (or 1xEV-DV, 1xEV-DO or 3xEV-DV).

For FIG. 15, oscillator circuitry for clocking peripheral interface 810 has frequencies determined by one or more crystals and PLLs (phase lock loop) and include a real time clock (RTC, time/date functions). Batteries such as a lithium-ion battery and recharger provide power to the system and battery data on separate lines from a battery pack. MADC (Monitoring ADC) and analog input multiplexer monitor on-chip charging voltage and current, and battery voltage lines, and off-chip battery voltage, current, temperature) under control of a power control state machine. Battery monitoring is provided by either or both of 1-Wire and/or an HDQ interface.

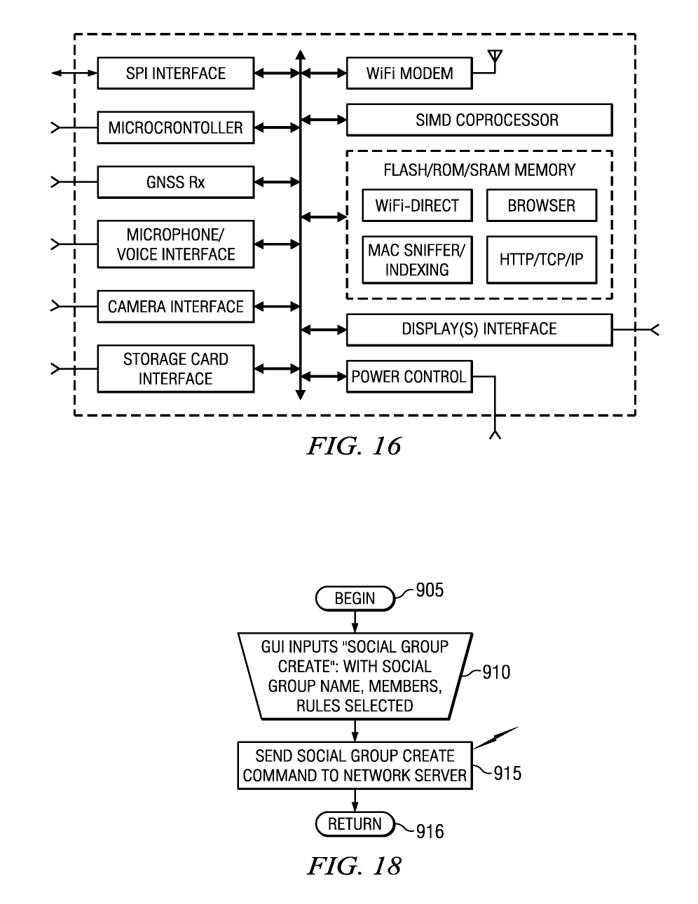

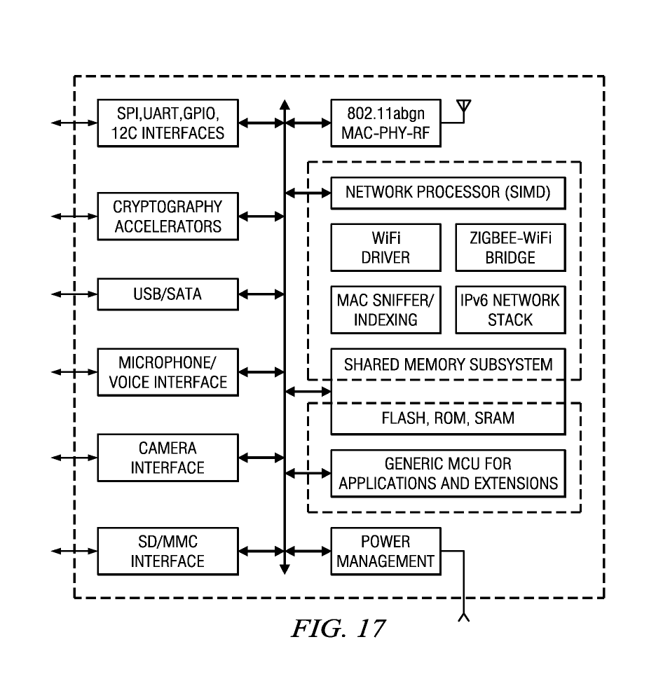

In FIG. 16-17, block diagrams depict another way of detailing differently-constituted embodiments of Peripheral I/F Chip or core 810 (110, 710) that can be used in other Figures such as FIG. 4, FIG. 11, and FIGS. 12-15. In FIG. 16, one type of embodiment integrates Wi-Fi modem, SPI interface, microcontroller MCU supported by a SIMD coprocessor, GNSS global navigation satellite receiver interface, microphone/audio/voice interface, camera interface, storage card interface (e.g. SD/MMC), and display interface. In FIG. 16, a storage section has Flash/ROM/SRAM memory with WiFi-Direct, TCP/IP, HTTP server, MAC Sniffer/Indexing (see FIGS. 5-9, and FIGS. 18-21), and browser sections or modules. Content capture efficiently goes into a single peripheral interface SIMD processor that utilizes sniffing of MAC addresses when a file is transferred or captured to index files.

In FIG. 17, dotted lines surround an example of one desirable core partitioning approach. A SIMD network processor has a shared memory subsystem has Flash/ROM/SRAM memory with generic MCU software for apps and extensions. The shared memory subsystem also supports the network processor. Wi-Fi drivers, WiFi-Direct, TCP/IPv6 network stack, MAC Sniffer/Indexing (see FIGS. 5-9, and FIGS. 18-21), Zigbee-WiFi bridge, and any other suitable modules such as discussed elsewhere herein are included in more or less close association with the SIMD network processor. The SIMD utilizes sniffing of MAC addresses when a file is transferred or captured to index files, see e.g. FIG. 5. Compared with FIG. 16, the architecture embodiment in FIG. 17 lacks a specific satellite receiver interface, but includes cryptography accelerators and a USB/SATA wired data interface. The inclusion or omission of various modules in various embodiments is desirably used by designers and manufacturers to differentiate products and bring value to end-users by including desired functionality and omitting other functionality to economically fulfill demand in particular market segments.

Some examples of protocols and layers suitably supported in a stack as desired for FIGS. 16-17 are pointed out next. Protocols at any of various network Layers can be used in various embodiments. Various Layers are executed generally from higher Layer to lower Layer on transmit, and generally from lower Layer to higher Layer on receive. HTTP is an Application Layer (Layer 7) protocol, and as such involves user interaction or access for end-user service provisioning. Simple Mail Transfer Protocol (SMTP) is one e-mail transmission protocol for IP networks. Post Office Protocol (POP) is an application-layer (Layer 7) protocol for a client retrieving e-mail from a TCP/IP connected server. File Transfer Protocol FTP involves TCP/IP transfer of files between hosts with high bandwidth and error-free data integrity, but unrestricted length of latency. Layer 6 is a Presentation Layer that handles format conversions, changing data representations, packet assembly/disassembly, and can include encryption/decryption. SIP is a Session Layer (Layer 5) protocol. The session layer controls dialogs and connections (sessions) between computers, to establish, manage and terminate the connections between a local application and a remote application. TCP and UDP are examples of Transport Layer (Layer 4) protocols, which control a given link through flow control, segmentation/de-segmentation, and error control. IP (Internet Protocol) is an example of a Link Layer (Layer 3) network layer protocol which handles procedures of network global addressing, routing, congestion control, and logical name translation into physical addresses. IP protocol has an updated version IPv6 that has extended 16-byte source address and 16-byte destination address, point-to-point security (IPSEC), improved QoS indications, and link local address. Turning to Layer 2, Ethernet and WLAN are both Data Link Layer (Layer 2) protocols, and they use a Destination MAC address and a Source MAC address among other metadata. When moving data packets over wireless, the Layer 2 segment is replaced between a wired and a wireless network segment by header translation. Layer 1 is the physical PHY layer.

In each of FIGS. 16 and 17, an integrated SIMD network coprocessor processes, converts, and transforms sensor and peripheral data with a small amount of internal memory that is shared with the Wi-Fi system. The SIMD block also executes various content encodes and decodes and network processing. This overcomes the power overheads and costs associated with external-DRAM based systems and provides a remarkably effective and modular upgrade for existing mobile designs without significant impact to previous design software, hardware, and cost. This also enables contextual coupling between these subsystems so that desired information and media may be shared between participating groups in an automated way.

In FIGS. 16 and 17, two exemplary types of such a Wi-Fi peripheral interface embodiment 810 integrate a special combination of a microcontroller, a SIMD coprocessor, a Wi-Fi subsystem, flash, ROM, and SRAM. The differentiation is in the combination of these components with some signal processing modules that enable this SOC to operate at lower power and cost than existing DDR based systems which might be expanded to provide the same set of peripheral features. Remarkably, this peripheral subsystem embodiment can also enable an open software development environment enabling the manufacturer to make tradeoffs between various Wi-Fi features and peripheral features such as in the resolution of screen supported and the number of stations supported. In addition, this type of embodiment enables manufacturers to leverage Wi-Fi contextual information (such as the MAC addresses of surrounding friends or GPS location) with sensor, camera, and SD card transactions in a way that will further reduce power consumption and enhance user experience.

The combined functionality can be advantageously accelerated with a small amount of memory such as sequential image encoding/decoding, differential sensor encoding/decoding, and transformative signal encoding/decoding with a Wi-Fi subsystem in such a way that the memory to operate the Wi-Fi subsystem can be leveraged by the various encoding/decoding schemes through a shared internal memory architecture to enable data to be transformed and communicated directly between the integrated Wi-Fi subsystem to and from peripheral subsystems such as camera, display, GPS, and MMC/SD cards in real-time.

In FIGS. 16-17, the main processor in peripheral interface 810 desirably includes DSP or DSP-like capabilities for higher code efficiency and lower MIPS (millions of instructions per second) when executing content processing as an audio codec or VGA/sub-VGA image processor. ARM® Cortex™-M4 is one such suitable core. In fact, lowering the MIPS consumption for signal processing beneficially also allows a lower clock rate and lower power consumption. SIMD (single instruction multiple data) instructions each perform multiple smaller operations in one cycle allowing advantageously high content processing throughput and speedup. The SIMD operations process packed data, which reduces the number of memory load instructions and confers additional code efficiency and power efficiency. An extended integer multiply-accumulate unit performs a single multiply and accumulate operation in one cycle. A floating point unit FPU accelerates single precision floating point operations using a decoupled floating point pipeline, single-precision floating point add, subtract, multiply, divide, multiply-accumulate, and square root. Double-precision results can be generated by combining multiply-accumulate operations for single-precision.

The DSP-like capabilities in the SIMD coprocessor of peripheral interface 810 can lead to significant code efficiency in audio, video and low power sensor data processing and compression/decompression applications that desirably use any of the complicated electronic operations represented by the following expressions. Note that most such operations are dominated by multiply-accumulates (MACs) that would take multiple instructions to implement. (This processor-specific meaning of “MAC” as multiply-accumulate should not be confused with the Media Access Control MAC in a WLAN peripheral or other network peripheral.)

Finite impulse response (FIR) filters implemented in software (smoothing):

$$y [ n ] = {\sum }_{k = 0}^{N - 1} h [ k ] x [ n - k ] \qquad ( 1 )$$

Infinite impulse response (IIR) filters implemented in software (audio equalization):

y[n]=b₀x[n]+b₁x[n−1]+b₂x[n−2]+a₁y[n−1]+a₂y[n−2] (2)

FFT and DCT implemented in software (audio/video codecs):

Y[k₁]=X[k₁]+X[k₂]

Y[k₂]=(X[k₁]−X[k₂])e^{-jω} (3)

Bi-Quads (audio filtering):

y[n]=b₀x[n]+b₁x[n−1]+b₂x[n−2]−a₁y[n−1]−a₂y[n−2] (4)

In FIGS. 16 and 17, peripheral interface 810 has control circuitry that is responsive to activity in its peripherals. Multiple peripherals can or will trigger interrupts if activity is detected by them and then communicate such interrupts to the peripheral interface 810 and/or to host processor 880. Some peripherals suitably convey interrupts by general purpose input/output GPIO, while other peripherals suitably trigger interrupts with in-band mechanisms such as SDIO.

In FIGS. 16 and 17, a Power Control block or a Power Management block is provided for Peripheral Interface 810. Peripheral interface 810 sleeps until a WLAN radio 870 interrupt is received. The WLAN radio 870 here can itself sleep, but wakes up every few hundred milliseconds to see if there are any messages for it when connected to a network or another device. The WLAN radio 870 will wake up less frequently when not connected. These operations provide or implement a method of initiating sleep and sequencing deactivations of blocks in peripheral interface 810 for power-saving sleep as well as waking them up. When peripheral interface 810 sleeps in such time-controlled power-saving mode, an instance of discovery of information elements (FIG. 10 IEs) to a specific service class of interest in a beacon wakes it up after a predetermined time interval.

In FIGS. 15-17, Peripheral Interface 810 has suitable control circuitry responsive to activity in its peripherals such as by any utilized protocols among I2C, UART, SPI, SDIO, SD/MMC or otherwise. The software inside Peripheral Interface 810 can periodically (or based on host 880 command) enter a lower-power mode which consumes only few uA from battery. In this mode the RTC (real time clock) and timer are used by a wakeup circuit to wake up at predetermined time. The wakeup circuit is arranged to also wake up from very low power sleep modes when incoming activity on SPI or UART occurs, for instance. This wakeup is useful for responding to an external processor 880 without the external processor having to directly control Peripheral Interface 810 power/sleep states. Various cores such as GPS 850, WLAN 870, MCU, SIMD processor, memory modules, test/debug, are suitably provided with power management circuits and a PRCM (power, resets control module) suitably is connected to such power management circuits to provide a degree of coordination. For some background, see hereby-incorporated US Patent Application Publication 20080307240 “Power Management Electronic Circuits, Systems and Methods and Processes of Manufacture,” dated Dec. 11, 2008 (TI-66478).

One example of a power management process embodiment herein desirably provides a “please wake me up” power-conserving mode wherein the rest of the device 800 sleeps and then the Peripheral Interface 810 wakes it up. A WLAN radio in the peripheral interface 810 periodically wakes up and scans e.g. Ch. 1, 6, and 11 for any beacon instances that have FIG. 10 IEs of interest to local device 800. When the peripheral interface 810 finds such a beacon, it responds and only wakes up Host 880 if need be. In one use-case, the rest of the mobile device 880, 890 is OFF or in deep(est) sleep as in FIG. 12. Peripheral Interface 810 wakes up every predetermined time interval of X milliseconds or seconds to listen to FIG. 3 WLAN AP/GO for any incoming packet for itself. This is a WLAN-ELP (extra-low power) mode in which even the FIGS. 16-17 SIMD network processor and apps MCU processor inside Peripheral Interface 810 itself are in power-gated sleep mode to save power. Peripheral Interface 810 WLAN core wakes up after each interval, and swiftly receives and detects any packet waiting for Peripheral Interface 810 in the FIG. 3 network AP/GO. When a packet is found to be waiting in AP/GO, Peripheral Interface 810 processes the packet to any extent needed for its control purposes, and then wakes up the FIGS. 16-17 SIMD network processor and apps subsystem in the same SoC 810 locally. Its application specific code then parses/interprets the TCP/UDP/Raw packet and takes any appropriate action either in Peripheral Interface 810. Alternatively or in addition, Peripheral Interface 810 initiates some embedded application running in the Peripheral Interface 810 SoC itself. Such embedded application can be an internet voice call or a file push/pull of FIGS. 6-8 initiated via e.g. SIP protocol in session Layer (Layer 5), or other beneficial operations to establish, manage and terminate connections.

Signaling Protocol SIP provides for graceful establishment, termination, and restart procedures over TCP or UDP. Callers and callees are identified by SIP addresses. When making a SIP call, a caller first locates the appropriate server and then sends a SIP request, e.g. an invitation, to which a callee sends a response message. SIP commands are Invite, Ack, Bye, Cancel, Options, and Register (with server). A SIP request may be redirected or may trigger a chain of new SIP requests by proxies. The SIP syntax and header field are similar to HTTP. Response codes include Success, Busy, or any of several failures or problem codes.

Regarding power saving for FIG. 16-17 Peripheral Interface 810 seen as a FIG. 4 client, a process embodiment operating in one type of power saving mode can provide special operations of the client 810 to utilize the network server 150 so that by using the server 150, the client device 810 uses less power than the same device interrogating Wi-Fi Direct peers.

In FIG. 15-17, peripheral interface 810 operates as a multipurpose smart peripheral for various phone applications, and as a low power hub/processor for positioning applications such as using a sensor plus GPS plus Wi-Fi. Operations to support the positioning applications include automatic positioning database download and position upload to the internet when Wi-Fi is available. As illustrated in FIGS. 4-10, buddy searching is supported by automatically-performed, low power background Wi-Fi packet sniffing. Based on the results of the packet sniffing, low power media upload/download is executed in the background and thus simplifies and enhances the user experience.

Moreover the embedded processor 811 and its applications can, on command, convert and store cell, VoIP or other phone audio into always-connected internet-accessible secure media storage. The peripheral interface 810 is coupled via a system bus to act as a bridge for low-power Zigbee/LPRF to Wi-Fi/Internet to support low power sensor/LPRF device management, data aggregation and processing. Moreover, the peripheral interface 810 has enough processing power to also be used on command for content decoding and rendering, such as for content playing at lower power with the phone application processor 880 inactive. Peripheral interface 810 can execute and provide low power VoIP Internet phone with the phone application processor 880 inactive.

The skilled worker uses and adapts the integrated circuits, cores and modules to the particular parts of device and system embodiments as appropriate to the functions intended and in a manner optimally combined or partitioned between the circuits and modules for application products now known or hereafter devised for increased, partitioned or selectively determinable advantages.

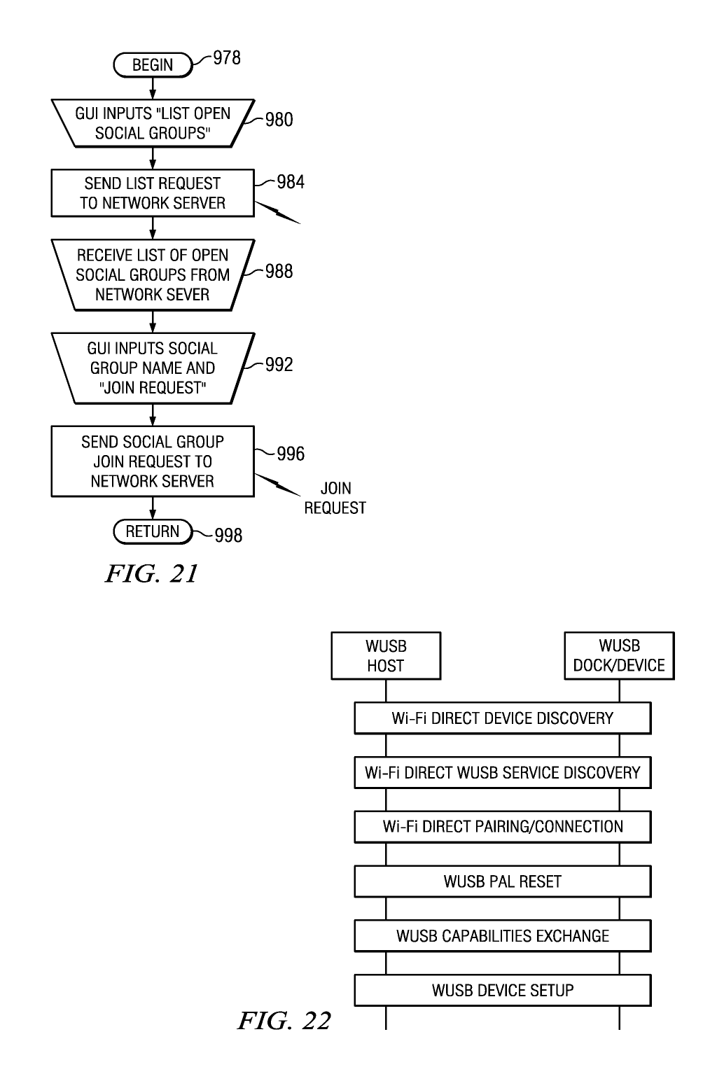

FIGS. 18-21 show some process embodiments to constitute and modify an electronic social group. In FIG. 18 a process embodiment for a STA to start or initially constitute, an electronic social group can be executed in a mobile device STA to communicate with a network server process of FIG. 19. In FIG. 19 a new social group process embodiment on the server side is provided in network server 150 of FIG. 4. In FIG. 20, a station STA responds to an invitation from the network server 150 to join an electronic social group, or not. In FIG. 21, a station STA initiates a request to join an existing social group.

Notice that for a station to “join” an electronic social group involves adding that station to electronic membership herein, which is more than a simple act of a station being powered on, or physically coming within, communicative range of another station. Instead, the electronic membership involves adding the station to a set of electronic information and permissions defining the social group thereby to affect, modulate, organize, coordinate or control operations of the other electronic members and the station itself, in terms of capability to sniff, pull and push content and other social group-related operations.

In FIG. 18, a FIG. 4 station STA or the Network Server 150 participates in the electronic creation of a social group, such as by commands Social Group Create, Social Group Join, Social Group Join Request, Social Group Join Approval, Sponsor, Decline, and Resign. These commands are mnemonically-named to assist description of some module embodiments and process embodiments for electronic social group formation herein that are contemplated to operate above, beyond, or independently relative to lower-level networking operations for Wi-Fi and P2P operations such as WiFi-Direct. Notice that “social group” or “electronic social group” as used herein refers to this high-level formation and also should not be regarded as the same thing as a Group that in WiFi-Direct has its WiFi-Direct Group Owner (GO).

In FIG. 18, to start a new social group, operations commence with BEGIN 905 and then in a step 910 a user inputs a Group Create command to the Network Server 150 with a name of the group, e.g. “Poetry Club” and a proposed list of member STAs identified in some suitable way, such as by e-mail address. The requesting STA can also identify and request background group formation rules pre-stored for the social group module embodiment in Network Server 150, by clicking on alternatives such as “Invitation Only,” “Open Group,” “Sponsored Admission,” etc. Then in a step 915, the user's STA sends the Group Create command with the associated just-described information to network server 150. The STA may also request that the proposed group will have asymmetric ties (subordinate and super-ordinate relationships). RETURN 916 is reached for this STA group formation module in due course.

In FIG. 19, operations in Network Server 150 commence with BEGIN 918 and a step 920 receives the Social Group Create command with the associated above-described information. If the STA requests that the proposed group will have asymmetric ties (subordinate and super-ordinate relationships), then the network server 150 replies in step 920 with a fill-out screen so that the requesting client STA can define those relationships. If at a decision step 925, the requested group will use sponsors to regulate admission, the network server sends Sponsoring Request communications at a step 930 to the proposed sponsors. Associated e-mail can explain their proposed privileges. Sponsors can be initiatory or reactive or both. Initiatory sponsors can actively propose new group members. Reactive sponsors can vote to approve or disapprove a Join Request to the group from a requesting STA. A station STA replies with a Sponsor Accept command to accept a sponsoring role. In case of a sponsored group, a decision step 935 determines whether sponsor(s) have sufficiently OK'd a candidate member and, if so, go to a step 940 that sends invitation communications and/or e-mails to the candidates with copy to copyees such as interested sponsors. If at a decision step 925, the requested group does not use sponsors to regulate admission, operations branch directly to that step 940 in the network server 150. After invitation step 940, network server 150 further electronically receives any Social Group Join reply from a Candidate member and executes a step 945 that sends a Social Group Admit command to each new electronic member and copyees or sends a Decline Acknowledgement reply as applicable. A further step 950 enters/updates the Social Group information for all the relevant stations in the Network Server 150 database comprised of information such as in FIG. 4A and FIG. 4B that is accumulated for all the Social Groups so far constituted. Then RETURN 952 is reached.

In FIG. 19, network server 150 is provided with multiple software modules that establish various rules and options based on which a group can be formed. Network server 150 processes inputs from the various stations STA to form one or more electronic social groups. Network server 150 acknowledges the requesting STA of FIG. 18 and sends invitations constructed from the information, if any, provided by the requesting. STA using pre-stored invitation templates or macros briefly describing the social group and the social group formation rules and any asymmetric ties of which the invited station should be aware.

In FIG. 20, operations at each invited STA commence with BEGIN 954 and a step 955 receives the Social Group Invitation from Network Server 150 with suitable associated information such as name of social group, purpose, type of rules, deadline for reply. User GUI step 960 inputs Join, Decline, or No-Input. A decision step 965 responds to the input from GUI step 960 and sends a Social Group Decline command back to Network Server 150 telling if User input was Decline or No-input before deadline. Otherwise, operations go from decision step 965 to a send step 975 that sends a Group Join command back to Network Server 150 if User input was “Join” prior to the deadline to join the group. A RETURN 976 is reached after either sending step 970 or 975. Some module embodiments in FIG. 19 Network Server 150 can invite some STAs to be sponsors. Sponsors then accept sponsorship (or not) according to a process at their STA analogous to FIG. 20 acceptance of membership. Sponsors subsequently can Sponsor Approve (or not) candidate members according to a process at their STA analogous to FIG. 20 acceptance of membership, except that, under the social group rules at the Network Server 150, a voting procedure may be executed at FIG. 19 step 935 in Network Server 150 based on inputs from multiple sponsors to then collective determine whether the candidate is to be invited to the particular social group.

In FIG. 21, STA operations commence with BEGIN 978. Using a GUI input step 980 and a wireless sending step 984, a station STA can interrogate the network server 150 to see a list of open social groups. Network Server 150 replies and the requesting STA receives a list of Open Social Groups at a step 988. Some of these social groups may be sponsored social groups. To join an open social group, the STA at a GUI input step 992 and wireless sending step 996 sends a Join Request identifying the social group.

Responsively in FIG. 19, the Network Server 150 responds to the Join Request received at step 920. If the social group is open and unsponsored, Network Server 150 automatically sends a Social Group Join Approval reply that admits into the social group the STA making the Join Request. If the social group is open and sponsored, Network Server 150 executes the other FIG. 19 steps that obtain sponsor approval, if any.

If the social group is open and sponsored, network server 150 sends the request to the sponsoring station(s), and they reply with a Group Admit (or not) under applicable voting rules. In a group that uses initiatory sponsors, any of such sponsors can send Sponsor requests to the network server for voting by any sponsors with reactive sponsor privileges for that social group. If the Join Request is not approved, then the network server 150 automatically sends a regret-reply to the original station STA that made the Join Request; otherwise the reply goes to the initiatory sponsor instead. If the Join Request is approved, then the network server 150 automatically updates the data structure of FIG. 4A, and the data structure of FIG. 4B if used. Network server 150 sends a Join Approval reply that admits into the social group the STA making the Join Request and copies the sponsor(s). In the Join Approval reply to the new social group member STA, Network server 150 includes the MAC addresses for which the social group structure permits sniffing, etc., by the joining STA as defined by the server data structure(s). These MAC addresses constitute the friends list of FIG. 4A as referred to elsewhere herein, which FIG. 4A more generally also is called a social group electronic membership list or data structure herein.

Note that different module embodiments representing process embodiments can provide numerous kinds of electronic social group formation rules and combinations of rules as described, or with suitable alternatives. Also, some embodiments provide supervening administrative controls over the electronic social groups, such as in a school environment, wherein inappropriate formations can be adjusted or terminated. Some other process embodiments provide automatically-emergent social group formation procedures that automatically accumulate stations into social groups (or conversely prune the social groups) based on criteria such as similar station or user characteristics, similar station operations or behaviors, and/or needed members having complementing interests, diverse characteristics and/or diverse task capabilities.

An STA sends a Resign command to the network server 150, whereupon the server 150 takes a Resign branch from step 920 to step 950, and either deletes the STA from the group in FIG. 4A or makes an entry for that STA in an ex-member field. Also the server 150 can occasionally administratively monitor the social groups when they are presented as in FIG. 4B. If over time most of the members have turned off their Sniff and Push privileges with respect to all the other stations, the network server can send a message to all stations in the social group giving them a deadline to confirm their social group electronic membership or be deleted. Each station in the social group that either Resigns or fails to confirm its social group electronic membership can be deleted from the social group. (Notice that “membership” or “electronic membership” of stations in an electronic social group of people to electronically network, say, a club should not be confused with non-electronic membership in the club, for instance. Deleting electronic membership in an electronic social group does not necessarily cancel membership in the actual social group of people which the electronic social group was intended to facilitate.) Also, if all the stations in the social group have resigned or failed to confirm membership, then the social group itself can be deleted from the server if it is administratively desirable for the process embodiment.

In FIGS. 22-26, description turns to various WUSB (Wireless USB) operations such as for fast wireless content transfers between FIG. 2A mobile devices, or for linking a mobile device and a FIG. 2B docking station (or ‘dock’ herein). A WUSB session is initiated by a WUSB host that discovers a WUSB device or dock with a device class service(s) of interest, e.g. see TABLE 2. These services are initially presented to the WUSB host user. The WUSB host user may elect to first pair with the WUSB device or WUSB dock using WPS PBC (Wi-Fi Protected Setup Push-Button Configuration), may defer an action, or may indicate that discovery of some specific WUSB dock/device services are to be ignored in the future. After successfully pairing with a WUSB dock/device, the WUSB host may utilize and subsequently disconnect from the service as described below. Future connection with a dock/device service is user initiated and pairing is not required.

FIG. 22 depicts WUSB session setup between a WUSB host and WUSB dock or device. The process steps are shown as horizontal blocks including two-way communications between WUSB Host and WUSB Dock/Device, and the steps proceed in a timewise downward direction in FIG. 22. Session setup begins with Wi-Fi Direct Device Discovery wherein discovery discovers, determines, or verifies that Wi-Fi Direct (P2P) is supported. Then Wi-Fi Direct WUSB Service Discovery is executed. A succeeding step provides first-time pairing and connection under Wi-Fi Direct. Then a WUSB Protocol Abstraction Layer PAL reset occurs. WUSB Capabilities Exchange follows, and then WUSB Device Setup is performed. Each of these steps is described further in order hereinbelow.

In FIG. 22, Wi-Fi Direct Device Discovery, a WUSB entity uses the Wi-Fi Direct Device Discovery protocol to discover other WUSB entities. In device discovery, operations in each FIG. 3 Wi-Fi Direct device STAi that is not-yet P2P-connected to the wireless network periodically execute a wakeup and listen for 100 ms on e.g. Channels 1, 6, and 11 to see if there is an information element (IE in FIG. 10) in a beacon for a service class of interest, see e.g. TABLE 2. If so; availability of content/service for that device is subsequently probed-for, so the beaconing device (AP/GO) can know both the applicable device MAC address and social group device MAC address that has available content/service.

In Wi-Fi Direct WUSB Service Discovery and Wi-Fi Direct group formation, WUSB Discovery builds upon P2P Device Discovery to enable a WUSB Host Device to quickly find a WUSB Peripheral/Hub Device. WUSB Host Device determines whether or not to form a connection that can lead to a subsequent WUSB Session. WUSB devices perform and comply with P2P Device Discovery with the following additions. An additional WUSB information element (WUSB IE) as in TABLE 1 is inserted in all beacon, probe request and probe response frames. The WUSB IE carries basic information such as device type and device-status to facilitate the decision of a WUSB user/device to establish a connection with a peer WUSB device.

A Wi-Fi Serial Bus Device that is associated with an infrastructure AP and is operating as a Wi-Fi P2P device responds to Probe Requests containing a P2P IE, WUSB IE and a P2P wildcard SSID with a Probe Response frame. The Probe Response frame includes the P2P IE and WUSB IE to improve discoverability. This Probe Response frame is sent on the Wi-Fi channel on which the Probe Request was received.

A given WUSB Device could be both WUSB Host and WUSB Peripheral/Hub capable or may have only one such capability or role df that sort. The intended role is established prior to connection setup. The WUSB Device advertises that particular intended role as one of WUSB Host, WUSB Peripheral, or Hub, prior to connection setup and WUSB capability negotiation.

TABLE 1
WUSB IE STRUCTURE

| | | Value | |
|---|---|---|---|
| WUSB IE | Size (octets) | (Hexadecimal) | Description |
| Element ID | 1 | DD | vendor specific |
| Length | 1 | Variable | Length of following IE |
| | | | fields in octets. |
| OUI | 3 | 50 6F 9A | WFA Specific OUI |
| OUI Type | 1 | AA | 0xAA indicates WUSB |
| | | | v1.0 |
| WUSB | Sub-elements | Variable | At least one sub-element |

The Wi-Fi Direct WUSB Service Discovery step in FIG. 22 communicates or discovers specific Wi-Fi Serial Bus Capabilities (Services like audio, video, storage, etc.). Codes representing each service are specified as information sub-elements in TABLE 2. Each sub-element octet specified in the IE corresponds to a Base Class of service supported by the device. A WUSB Host identifies itself with a sub-element of 0xAA. A device may advertise multiple sub-elements.

TABLE 2
DEVICE BASE CLASSES*

| Base | Descriptor | |
|---|---|---|
| Class | Usage | Description |
| 00h | Device | Use class information in the Interface Descriptors |
| 01h | Interface | Audio |
| 02h | Both | Communications and CDC Control |
| 03h | Interface | HID (Human Interface Device) |
| 05h | Interface | Physical |
| 06h | Interface | Image |
| 07h | Interface | Printer |
| 08h | Interface | Mass Storage |
| 09h | Device | Hub |
| 0Ah | Interface | CDC-Data |
| 0Bh | Interface | Smart Card |
| 0Dh | Interface | Content Security |
| 0Eh | Interface | Video |
| 0Fh | Interface | Personal Healthcare |
| DCh | Both | Diagnostic Device |
| E0h | Interface | Wireless Controller |
| EFh | Both | Miscellaneous |
| FEh | Interface | Application Specific |
| FFh | Both | Vendor Specific |

(*http://www.usb.org/developers/defined_class)

In FIG. 22, Wi-Fi Direct WUSB Service Discovery (SD) process follows a sequence that is detailed next. For example, a Discover P2P Device command from application or WSC button initiates the Device Discovery process. A P2P Device1 performs a sequence of Scan all channels, Listen on Channel 1, Search on Channels 1, 6, 11; Listen on Channel 1, Search by sending a probe request on Channels 1, 6, 11 sequentially; Listen. P2P Device2 performs a sequence of Scan all channels, Listen on Channel 6, Search on Channels 1, 6, 11 sequentially; Listen on Channel 6. When P2P Device 2 receives a Probe Request on Channel 6, it responds on Channel 6. By this process, when P2P Device1 discovers P2P Device2, the Device Name and Device Type of Device2 are discovered. Then P2P Device1 sends another Probe Request on Channel 6 that receives a Probe Response, whereupon P2P Device 1 sends an SD Query (GAS Initial Request) on Channel 6 which is fulfilled by P2P Device2 sending an SD Response (GAS Initial Response) that delivers the Service information on P2P Device 2 on Channel 6. Thus, a two-way request/response sequence of device discovery probes for service information like that of TABLE 2. All the Probe Requests in this example include P2P IE, WSC IE, and Supp Reg IE. The Probe Responses include P2P IE, WSC IE, RSN IE (Robust Secure Network IE), and Supp Reg. IE. In various wireless system embodiments, discovery can operate over various channels. For the particular example of Wi-Fi Direct infrastructure, device discovery is suitably conveyed on 2.4 GHz channels 1, 6, and 11 per the Wi-Fi Direct specification. Some embodiments employ multiple rates and bandwidths for discovery to sniff as in FIG. 5, i.e. listen in on, a larger or smaller subset of Wi-Fi channels.

Suppose a WUSB device or dock with a service of interest to the discovering device is discovered. This service is indicated by the IE sub-element indicating Base Class in TABLE 2. Then the WUSB Host will pair with the device or dock using WPS PBC the first time they connect. Subsequent pairing is not required, and the Host may connect directly. When connecting to a WUSB device, the WUSB Host acts as a Wi-Fi Direct Group Owner GO.

Following Service discovery (SD), the Wi-Fi Direct group is formed with a Wi-Fi Direct Group formation procedure. A WUSB Host uses a Group Owner Intent Value of 15 to become the GO during GO negotiations. A WUSB device uses a Group Owner Intent Value less than 15. In a special use-case of WUSB peer-to-peer (P2P), suppose either WUSB entity can become the GO. Then if a WUSB entity receives a GO Negotiation Request with Group Owner Intent Value=15, it responds with a GO Negotiation Response with Group Owner Intent Value less than 15.

In GAS (Generic Advertisement Service) Layer 2 (Data Layer) transports advertisement protocol frames between a STA and network server 150 before authentication. AP relays the STA query to network server 150, and AP relays the response back to STA.

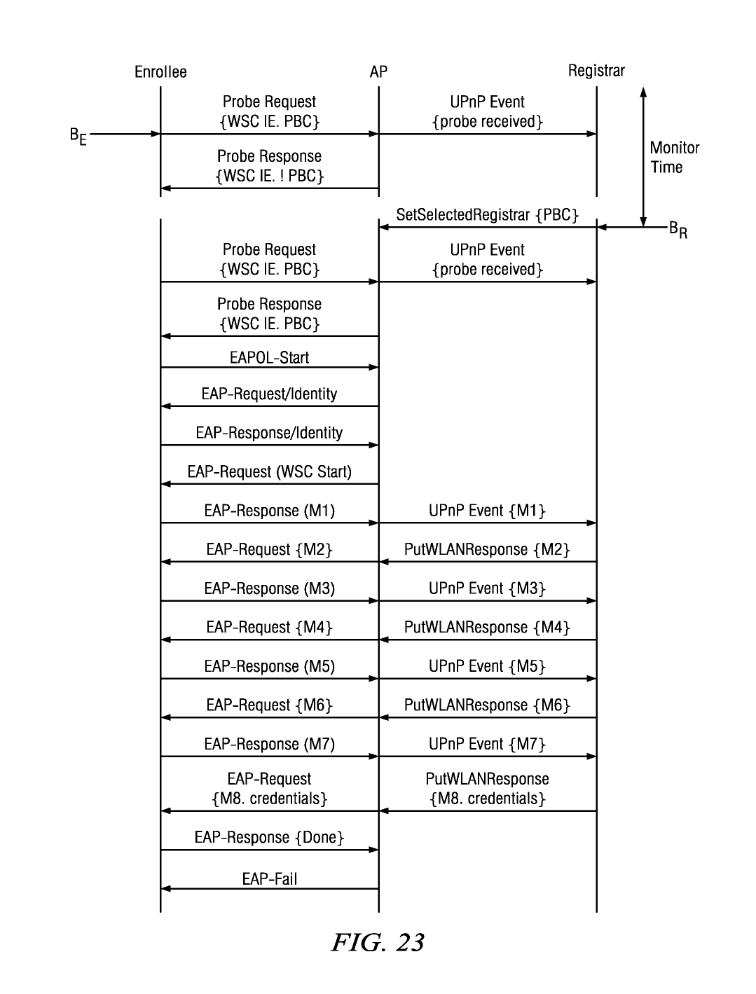

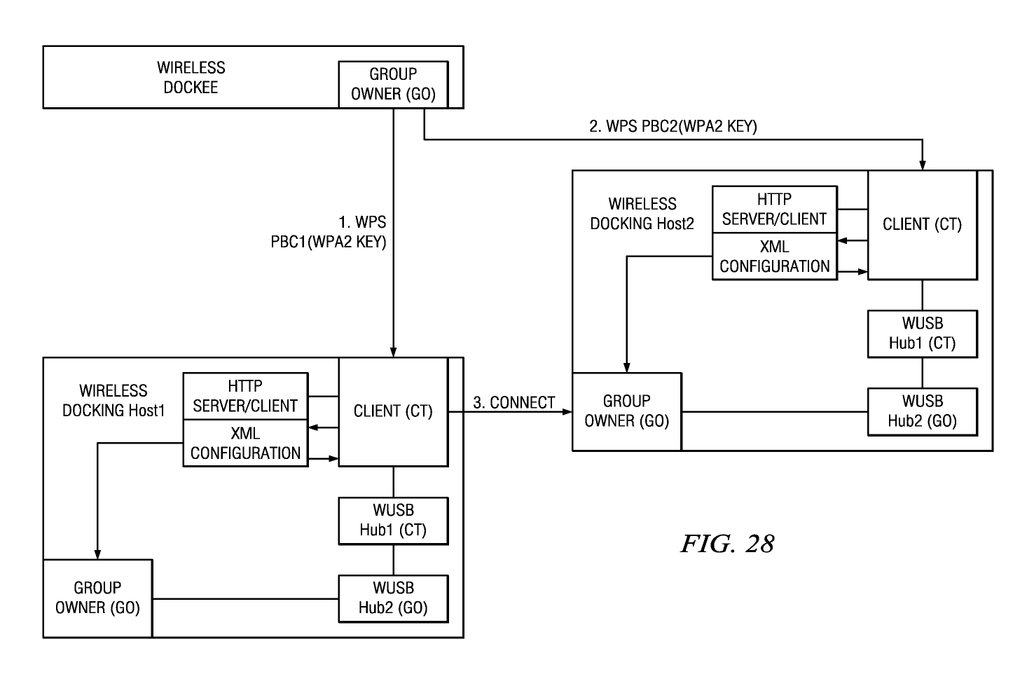

FIG. 23 depicts WPS PBC (Wi-Fi Protected Setup Push-Button Configuration). If a registrar is co-located with the AP, which is typically the case, then UPnP messages are not needed. The WPS PBC process is initiated by and from either the GO or Client's WPS PBC button being pushed. A monitor time of e.g. two minutes is provided, in which the button of the GO or Client to be paired must be pressed. Once paired, a Client (Peripheral or Hub) can request to join the network without repeating this procedure. UPnP uses TCP/IP, HTTP, and Extensible Markup Language (XML) to connect devices and manage data transfers between them, see XML examples in connection with FIG. 27.

Description turns now to the FIG. 22 steps of WUSB PAL Reset and WUSB Capabilities exchange. After a Wi-Fi Direct connection has been established, the WUSB Host sends a Reset Request to the WUSB Dock/Device by setting the appropriate Control Type Field in the WUSB PAL (Protocol Abstraction Layer) Packet Header to Reset. The WUSB dock or device responds to this request with a response packet with Reset control type field set, same Request ID, and Status field indicating no Error was encountered. Following successful WUSB PAL Reset in which the state of the WUSB dock or device is known, the WUSB Host sends a request to exchange capabilities information. This request is accomplished by setting a DeviceCapabilityExchange Control Type Field in the packet header. The WUSB dock or device responds with the same control type field and the list of USB Device Capabilities provided by that WUSB dock or device.

After Device Capabilities have been provided, the WUSB Host sends a Device Handle Request to the WUSB Dock or device by setting the appropriate control type field in the request packet header. The WUSB dock or device responds with the same request ID and control type field setting along with a handle to the device.

FIG. 23 compositely shows interrelated sequences of probe and authenticating communications between an Enrollee STA, a Wi-Fi access point AP and a Registrar module, e.g. at AP or network server 150. Probe Requests from Enrollee to AP lead to AP sending a probe-received UPnP Event to Registrar. Then a sequence of EAP (Extensible Authentication Protocol) communications between Enrollee and AP occur and result in AP sending UPnP Events {M1, 3, 5, 7} from AP to Registrar. Registrar responds with PutWLANResponse replies {M2, 4, 6, 8} and credentials. (EAP can handle authentication for wired Ethernet and wireless networks as well.)

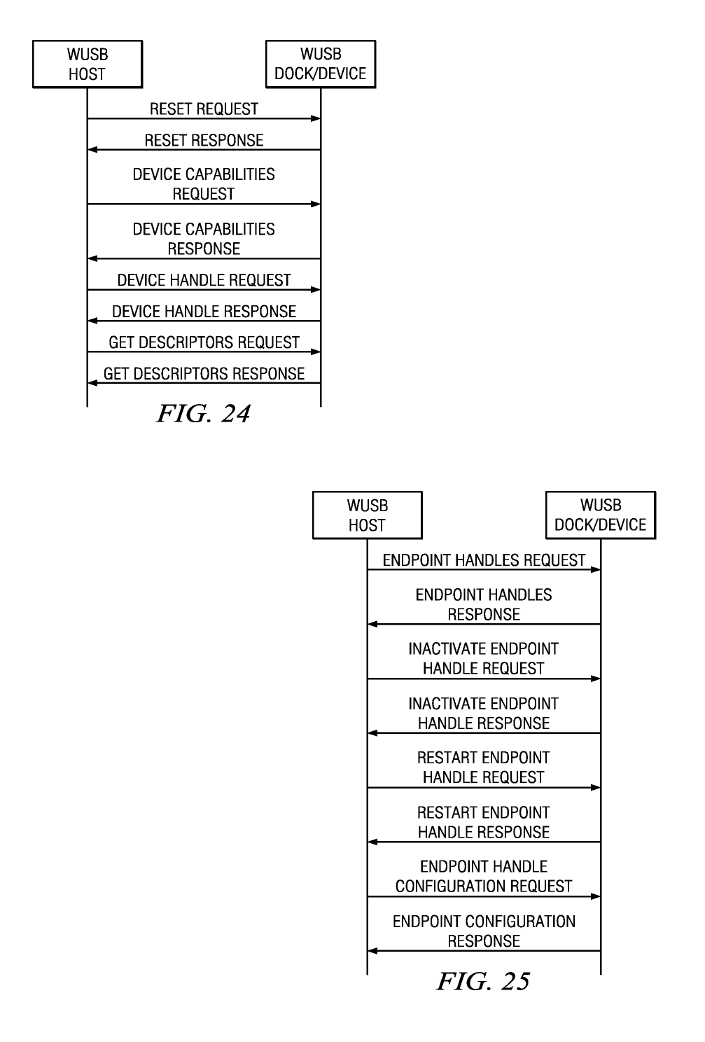

FIG. 24 shows a sequence diagram for WUSB PAL Reset, Device Capabilities, Device Handle Exchange, and Descriptors.

WUSB Device Setup is the last step shown in FIG. 22. After successful receipt of the device handle in FIG. 24, a WUSB Host will send a request for Endpoint Handles as in FIG. 25 by setting the appropriate control type field in the request packet. The WUSB dock or device responds with a list of Endpoint Handles belonging to the device handle first provided. The WUSB Host may subsequently delete, inactivate, restart, or clear transfers associated with a given endpoint by setting the appropriate control type field and providing the relevant Endpoint Handle to the WUSB dock or device. The WUSB dock or device will respond with reference to the same request ID, control type, and status indicating no error. FIG. 25 depicts a potential scenario for a sequence of endpoint requests and responses. When the WUSB Host has active endpoint handles associated with a WUSB dock or device, the WUSB Host configures and communicates with the endpoint using standard data transfer requests.

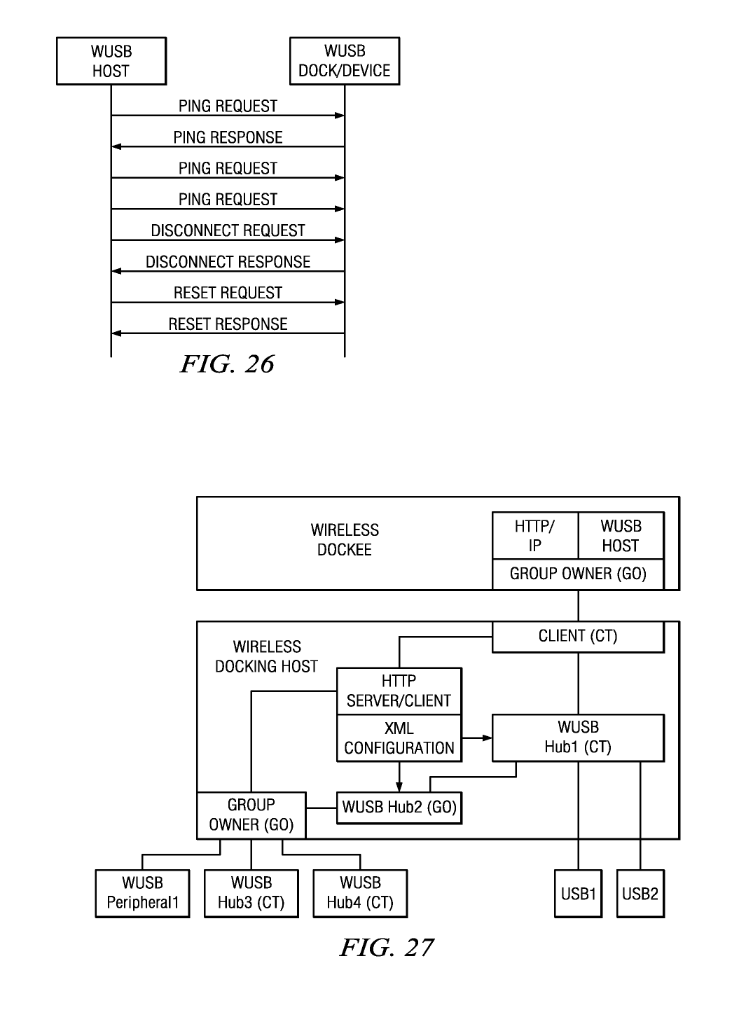

In FIG. 26, Host session management is performed. In the event that a WUSB connection is disrupted during an active session, the WUSB Host sends ping requests by setting the appropriate control type field in the request header. The WUSB dock or device may respond and, if it responds, the response includes same request ID and control type. Failure to respond to a predefined number of ping requests triggers the WUSB host to seek a connection in an alternate band or to disconnect and reset the PAL and start over. FIG. 26 depicts a potential scenario with its sequence of commands.

If the WUSB host successfully receives ping responses but is not receiving other WUSB transfer responses, the WUSB host inactivates and restarts operations involving the associated WUSB Endpoint Handles. If this fails, the WUSB host resets the WUSB PAL.

Turning to the subject of WUSB session disconnect, suppose the WUSB Host user wishes to terminate a WUSB Session or the WUSB Host code reaches a point at which such termination is called for. Then a request with control type set to the appropriate field is sent to WUSB dock or device. The WUSB dock or device responds with same request ID and control type with status indicating no error. The WUSB Host and WUSB dock or device then resets its internal state and goes back to device/service discovery mode.

WDH means Wireless Docking Host. Three different methods of WUSB are provided for wireless docking. 1) Configuration of WDH WUSB hubs, 2) WUSB Inter-WDH Communication/Configuration, and 3) Network/IP connectivity through WUSB RNDIS/CDC class device. Such RNDIS/CDC class device can be used to support or act like a variety of types of communications ports or modems and can do large data transfers such as for files and content. Communication is IP/HTTP based. Dockee supports both IP and WUSB based communication through its Wi-Fi Direct connection to a WDH.

Referring to FIG. 27, in a WDH WUSB Hub configuration process embodiment, when a dockee establishes a connection with a WDH, the dockee's MAC address is used to parse an XML file and configure its WUSB hubs with the XML-specified group of USB and WUSB devices. As noted earlier hereinabove, UPnP uses TCP/IP, HTTP, and Extensible Markup Language (XML) to connect devices and manage data transfers between them, see XML examples here.

In FIG. 27, each WDH supports concurrent Client STA and Group Owner GO operation with a Client based WUSB Hub which WDH exposes to the dockee. WDH also supports such concurrent Client STA and Group Owner GO operation with a GO based WUSB hub that is connected to the Client-based WUSB Hub as a device and that enables other WUSB hubs and WUSB peripherals to be connected to it.

In FIG. 27, different dockees connecting to a WDH may have different WUSB Client and GO Hub configurations. These different configurations are independently specified in the XML configuration file and are parsed by the WDH by the MAC address of the connected dockee. WDH can support simultaneous connection of two or more dockees. To do this, a separate concurrent Client role is supported by the Wi-Fi radio, and the MAC address(es) of any additional dockee(s) is used to parse a separate XML configuration of WUSB and USB hubs and peripherals. While WUSB hubs and peripherals can be independently instantiated, USB devices are to be shared. Determining which USB peripherals may be available to subsequent dockees may be based on various metrics that need not be elaborated here.

The XML configuration for the system of FIG. 27 is:

```
<Wireless Dockee1>
    <MAC Address> #$%$# </MAC Address>
    <WPA2 Key> #$@#$#$ </WPA2 Key>
    <Group Owner SSID>#$@#$#$</Group Owner SSID>
    <WUSB Hub1>
        <USB Device ID>#$@# </USB Device ID>
        <USB Device Class> Hub </USB Device Class>
        <USB1>
            <USB Device ID>#$@# </USB Device ID>
            <USB Device Class> Audio </USB Device Class>
            ... other properties
        </USB1>
        <USB2>
            <USB Device ID>#$@4</USB Device ID>
            <USB Device Class> Video </USB Device Class>
            ... other properties
        </USB2>
        <WUSB Hub2>
            <USB Device ID>#$@# </USB Device ID>
            <USB Device Class> Hub </USB Device Class>
            <Group Owner SSID>#$@#$#$</Group Owner SSID>
            <MAC Address> #$%$# </MAC Address>
            <WPA2 Key> #$@#$#$ </WPA2 Key>
            <WUSB Peripheral1>
                <MAC Address> #$%$# </MAC Address>
                <USB Device ID>#$@4</USB Device ID>
                <USB Device Class> HID </USB Device Class>
                ... other properties
            </WUSB Peripheral1>
            <WUSB Hub3>
                <MAC Address> #$%$# </MAC Address>
                <USB Device ID>#$@4</USB Device ID>
                <USB Device Class> Hub </USB Device Class>
                ... other properties
            </WUSB Hub3>
            <WUSB Hub4>
                <MAC Address> #$%$# </MAC Address>
                <USB Device ID>#$@4</USB Device ID>
                <USB Device Class> Hub </USB Device Class>
                ... other properties
            </WUSB Hub4>
        </WUSB Hub2>
    <WUSB Hub1>
</Wireless Dockee1>
```

FIG. 28 shows WDH WUSB inter-WDH communication and configuration, in addition to the XML configuration file for WUSB hubs and peripherals described for FIG. 27. In FIG. 28, every WDH supports WPS PBC (Wi-Fi Protected Setup Push-Button Configuration) in order to connect with a dockee and in order to establish connections between WDHs in a wireless docking environment WDE. Once the initial connection between a dockee and a first WDH—i.e. WDH1—has been established via WPS PBC, subsequent connection with that WDH1 is based on a dockee-initiated trigger and does not require the WPS PBC process to be repeated. If a dockee user wishes to make another WDH—WDH2—part of dockee's wireless docking environment (WDE), the dockee conducts WPS PBC with WDH2 with the same GO SSID, WPA2 key, and MAC address used to establish the first WPS connection with WDH1. The dockee GO SSID, WPA2 key and MAC address are subsequently used to automatically connect WDH2 into or belonging to the dockee's WDE as in FIG. 28.

In FIG. 28 step 1, the dockee GO first connects to WDH1 Client as just described hereinabove. The WPA2 key, Dockee GO ID, and MAC address are stored in the XML configuration file of WDH1. WDH1 immediately configures its WDH1 GO with the dockee GO SSID and WPA2 key (but with different MAC address) enabling WDH2 Client to connect (step not shown) to WDH1 GO. The dockee GO subsequently disconnects from WDH 1 Client and connects in a step 2 to WDH2 Client with WPS PBC. WDH2 immediately configures its GO with the dockee GO SSID and WPA2 key (but with different MAC address) enabling WDH1 Client to connect to WDH2 GO as in step 3 of FIG. 22. WDH1 sees a beacon from WDH2 with the GO SSID of the dockee WDH1 has previously paired with. Upon WDH1 discovering the beacon is from a WDH (WDH2), then WDH1 Client requests a connection with WDH2 GO and provides the appropriate WPA2 key.

Once the dockee disconnects from WDH2, the connection between WDH1 and WDH2 will be also discontinued. WDH2 will also send a connection request to the dockee if the dockee's GO SSID beacon is received. If the dockee accepts this connection, the connection between WDH1 and WDH2 is discontinued. If the dockee decides to disconnect from WDH2, the connection between WDH1 and WDH2 is re-established. The WUSB hub topology represented in the XML configuration file that would be used in each of these scenarios is listed below.

Dockee connection to WDH2 following connection to WDH1 (followed by WDH1 connection to WDH2)—WDH2 Configuration:

```
<Wireless Dockee1>
    <MAC Address> #$@#$#$ </MAC Address>
    <WPA2 Key> Dockee1 GO WPA2 Key </WPA2 Key>
    <Group Owner SSID>Dockee1 GO SSID</Group Owner SSID>
    <WUSB Hub1>
        <WUSB Hub2>
            <USB Device ID>#$@# </USB Device ID>
            <USB Device Class> Hub </USB Device Class>
            <Group Owner SSID>Dockee1 GO SSID</Group Owner
            SSID>
            <MAC Address> WDH2 MAC Address </MAC Address>
            <WPA2 Key> Dockee GO WPA2 Key </WPA2 Key>
            <WUSB Hub1>
                <MAC  Address>  WDH1  MAC  Address  </MAC
Address>
                <USB Device ID>#$@4</USB Device ID>
                <USB Device Class> Hub </USB Device Class>
                ... other properties
            </WUSB Hub1>
        </WUSB Hub2>
    </WUSB Hub1>
</Wireless Dockee1>
```

Dockee connection to WDH1 following connection to WDH2—WDH1 and WDH2 Configuration(similar):

```
<Wireless Dockee1>
    <MAC Address> #$@#$#$ </MAC Address>
    <WPA2 Key> Dockee1 GO WPA2 Key </WPA2 Key>
    <Group Owner SSID>Dockee GO SSID</Group Owner SSID>
    <WUSB Hub1>
        <WUSB Hub2>
            <USB Device ID>#$@# </USB Device ID>
            <USB Device Class> Hub </USB Device Class>
            <Group Owner SSID>Dockee1 GO SSID</Group Owner
            SSID>
            <MAC  Address>  WDH2  or  WDH1  MAC
Address  </MAC Address>
            <WPA2 Key> Dockee1 GO WPA2 Key </WPA2 Key>
        <WUSB Hub2>
    </WUSB Hub1>
<Wireless Dockee1>
```

Dockee disconnects WDH2 and maintains connection to WDH1—WDH1 Configuration:

```
<Wireless Dockee1>
    <MAC Address> #$@#$#$ </MAC Address>
    <WPA2 Key> Dockee1 GO WPA2 Key </WPA2 Key>
    <Group Owner SSID>Dockee1 GO SSID</Group Owner SSID>
    <WUSB Hub1>
        <WUSB Hub2>
            <USB Device ID>#$@# </USB Device ID>
            <USB Device Class> Hub </USB Device Class>
            <Group Owner SSID>Dockee1 GO SSID</Group Owner
            SSID>
            <MAC Address> WDH1 MAC Address </MAC Address>
            <WPA2 Key> Dockee1 GO WPA2 Key </WPA2 Key>
            <WUSB Hub1>
                <MAC  Address>  WDH2  MAC  Address
</MAC Address>
                <USB Device ID>#$@4</USB Device ID>
                <USB Device Class> Hub </USB Device Class>
                ... other properties
            </WUSB Hub1>
        </WUSB Hub2>
    </WUSB Hub1>
</Wireless Dockee1>
```

Once a group of WDHs have been paired with a dockee to establish them as part of the same WDE (or same dockee GO SSID/MAC address), their Client will listen for that Dockee GO SSID's beacons and request connection when received. A WDH that is connected to a dockee is arranged so that it cannot request an additional connection to another WDH—these requests are initiated by the other WDH.

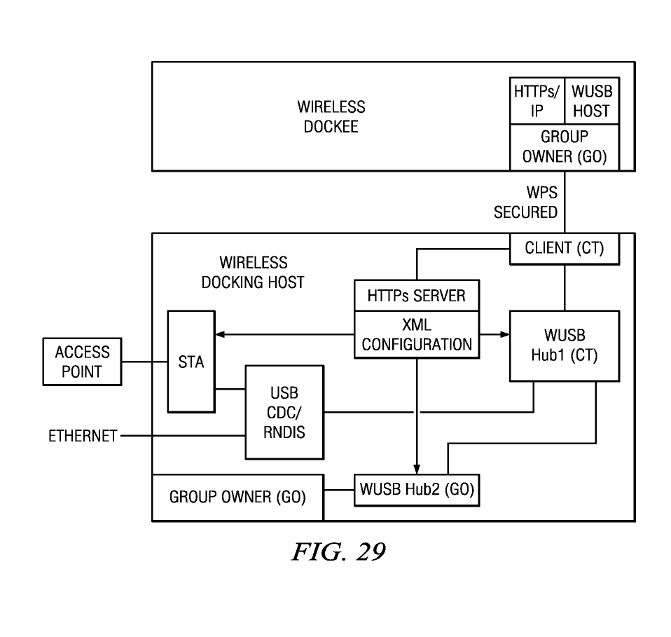

FIG. 29 depicts WDH WUSB CDC network access such as to support large data transfers. While it may be desirable to provide a dockee network access through a WDH, the mechanisms used to enable this desirably follow security protocols which can ensure enterprise-level security is not compromised. Because a WPS connection might not be considered from an enterprise perspective, a separate channel enabling the provision of network credentials may be desired. If this option is chosen, this channel is established using a secure (HTTPS) connection to the XML configuration file between the dockee and the WDH and that overrides security credentials provided by dockee at the STA.

FIG. 29 depicts how the WDH enables wireless and wired network access. RNDIS/CDC USB class device is used in the example here to support both Windows and Linux hosts. To support this RNDIS/CDC device class, WDH here concurrently supports a Client connected to dockee and additional STA connected to wireless network as its role during wireless network communication.

The XML configuration for the system depicted in FIG. 29 is:

```
<Wireless Dockee1>
    <MAC Address> #$%$# </MAC Address>
    <WPA2 Key> #$@#$#$ </WPA2 Key>
    <Group Owner SSID>#$@#$#$</Group Owner SSID>
    <WUSB Hub1>
        <USB Device ID>#$@# </USB Device ID>
        <USB Device Class> Hub </USB Device Class>
        <USB1>
            <USB Device ID>#$@# </USB Device ID>
            <USB Device Class> CDC </USB Device Class>
            <MAC Address> #$%$# </MAC Address>
            <WPA2 Key> #$@#$#$ </WPA2 Key>
            ... other properties
        </USB1>
        <WUSB Hub2>
            <USB Device ID>#$@# </USB Device ID>
            <USB Device Class> Hub </USB Device Class>
            <Group Owner SSID>#$@#$#$</Group Owner SSID>
            <MAC Address> #$%$# </MAC Address>
            <WPA2 Key> #$@#$#$ </WPA2 Key>
        </WUSB Hub2>
    </WUSB Hub1>
</Wireless Dockee1>
```

Various embodiments as described herein are manufactured in a process that prepares a particular design and printed wiring board (PWB) of the system unit and has an applications processor coupled to a modem, together with a host peripheral interface 110 (710, 810) embodiment and one or more peripherals coupled thereto. A storage, such as SDRAM and Flash memory is coupled to the system and has tables, configuration and parameters and an operating system HLOS, protected applications (PPAs and PAs), and other supervisory software. System testing tests operations of the integrated circuit(s) and system in actual application for efficiency and satisfactory operation for continuity of data transfer and content, display and other user interface operation and other such operation that is apparent to the human user and can be evaluated by system use. If further increased efficiency is called for, parameter(s) are reconfigured for further testing. Adjusted parameter(s) are loaded into the Flash memory or otherwise, components are assembled on PWB to produce resulting system units.

The electronic devices and process embodiments described herein are suitably supported by any one or more of RISC (reduced instruction set computing), CISC (complex instruction set computing), DSP (digital signal processors), microcontrollers, PC (personal computer) main microprocessors, math coprocessors, VLIW (very long instruction word), SIMD (single instruction multiple data) and MIMD (multiple instruction multiple data) processors and coprocessors as cores or standalone integrated circuits, and in other integrated circuits and arrays. Other types of integrated circuits are applied, such as ASICs (application specific integrated circuits) and gate arrays and all circuits to which the advantages of the improvements described herein commend their use.

ASPECTS (See Notes paragraph at end of this Aspects section.)

1A. The networking device claimed in claim 1 further comprising a local sensor, and wherein said peripheral interface processor is operable to automatically index and enable local preview of content from said local sensor, and said peripheral interface processor is operable with said modem to transmit a network address and a trigger signal representing controls to trigger automatic remote visibility at such network address.

1B. The networking device claimed in claim 1 wherein said peripheral interface processor is operable to actuate at least a portion of said user interface display, with low power relative to full use of the display, to represent a received message pertaining to remotely accessible content.

1C. The networking device claimed in claim 1 further comprising a second network modem of the same networking type as said first network modem, and wherein said first network modem and said second network modem are operable in a coexisting manner by said host processor and said peripheral interface processor.

1C1. The networking device claimed in claim 1C wherein said host processor is operable through said first modem to do browsing and then to disable said first modem, and said peripheral interface processor is operable to transfer at least one content file through said second modem provided said first modem is disabled and is coupled to further request host processor to disable said first modem in case said peripheral interface processor is maintaining a connection by said second modem.

1D. The networking device claimed in claim 1 further comprising a power control block for said peripheral interface processor to sleep and for said modem so that said modem is operable to sleep and wake up occasionally to monitor for either of an applicable network information element and message to said modem and then to generate a modem interrupt so that said peripheral interface processor wakes up when either a modem interrupt is received or host activity directed to said peripheral interface processor occurs.

1E. The networking device claimed in claim 1 wherein said modem is operable to generate a modem interrupt to said peripheral interface processor upon arrival at said modem of at least one information element indicating a specific service class pertinent to the device.

1F. The networking device claimed in claim 1 wherein said peripheral interface processor is responsive with said modem to execute device discovery operations to probe for a network address associated with availability of content/service applicable for the device.

1G. The networking device claimed in claim 1 wherein said peripheral interface processor is operable as a wireless docking host for serial content transfers by interne and wireless serial bus through wireless peer-to-peer connection.

1H. The networking device claimed in claim 1 wherein said peripheral interface processor and said modem are operable as a dockee to establish a wireless connection.

3A. The networking device claimed in claim 3 wherein said peripheral interface processor is operable with said modem to receive a remotely-originated requestor address and trigger signals representing controls to pull local content from said local content storage and to transmit such pulled local content via said modem to said requestor address, provided the requestor address is among the set of station addresses.

7A. The networking device claimed in claim 7 further comprising a satellite positioning receiver and wherein said sensors include at least one sensor selected from the group consisting of 1) accelerometer, 2) e-compass, 3) gyroscope, 4) positioning-support sensor; and said peripheral interface is operable to execute position information blending of information from said satellite positioning receiver and said sensors.

17A. The peripheral interface processor integrated circuit claimed in claim 17 wherein said processor includes a first programmable processor core and a second processor core operable for signal processing faster than said first processor core and coupled with said first processor core.

17A1. The peripheral interface processor integrated circuit claimed in claim 17A herein said second processor core is operable to execute content encodes and decodes and network processing.

17B. The peripheral interface processor integrated circuit claimed in claim 17 wherein said programmable processor has an updatable local storage for that set of other station addresses.

17C. The peripheral interface processor integrated circuit claimed in claim 17 wherein said programmable processor has an updatable local storage for that set of other station addresses further indexed according to type of social group.

17D. The peripheral interface processor integrated circuit claimed in claim 17 wherein said programmable processor is operable to generate interrogation signals to remotely access that set of other station addresses.

17E. The peripheral interface processor integrated circuit claimed in claim 17 wherein said programmable processor has a storage holding a networking program with a peer-to-peer networking protocol.

17F. The peripheral interface processor integrated circuit claimed in claim 17 wherein said, programmable processor has a storage holding instructions to discover remotely-located content and stream such discovered content back to the processor.

28A. The process claimed in claim 28 further comprising automatically indexing a sensor capture, and generating signals representing controls to transmit a network address and to trigger automatic remote visibility at the address.

28B. The process claimed in claim 28 wherein that set of other station addresses is indexed according to type of social group.

28C. The process claimed in claim 28 further comprising executing push and pull content transfers using a peer-to-peer networking protocol. 28D. The process claimed in claim 28 further comprising capturing at least some content from signals addressed to such received address further provided the received address is that of a subordinate station in the network, and preventing such capture when the received address is that of a super-ordinate station.

28E. The process claimed in claim 28 further comprising storing file identification data so that the file can be searched for.

Notes about Aspects above: Aspects are paragraphs which might be offered as claims in patent prosecution. The above dependently-written Aspects have leading digits and internal dependency designations to indicate the claims or aspects to which they pertain. Aspects having no internal dependency designations have leading digits and alphanumerics to indicate the position in the ordering of claims at which they might be situated if offered as claims in prosecution.

Processing circuitry comprehends digital, analog and mixed signal (digital/analog) integrated circuits, ASIC circuits, PALs, PLAs, decoders, memories, and programmable and nonprogrammable processors, microcontrollers and other circuitry. Internal and external couplings and connections can be ohmic, capacitive, inductive, photonic, and direct or indirect via intervening circuits or otherwise as desirable. Process diagrams herein are representative of flow diagrams for operations of any embodiments whether of hardware, software, or firmware, and processes of manufacture thereof. Flow diagrams and block diagrams are each interpretable as representing structure and/or process. While this invention has been described with reference to illustrative embodiments, this description is not to be construed in a limiting sense. Various modifications and combinations of the illustrative embodiments, as well as other embodiments of the invention may be made. The terms including, includes, having, has, with, or variants thereof are used in the detailed description and/or the claims to denote non-exhaustive inclusion in a manner similar to the term comprising. The appended claims and their equivalents should be interpreted to cover any such embodiments, modifications, and embodiments as fall within the scope of the invention.

What is claimed is:

1. A networking device comprising:
user interface circuits operable for user input and display;
a host processor coupled with said user interface circuits;
a network modem; and
a peripheral interface processor coupled with said host processor and operable to automatically execute content receptions and transmission through said network modem at least sometimes independently of said user interface circuits and said host processor; and
a local content storage coupled with said peripheral interface processor and wherein said peripheral interface processor is operable with said modem to transmit trigger signals representing controls to pull remote content from elsewhere and to subsequently receive such content via said modem for said local content storage.

2. The networking device claimed in claim 1 further comprising a power management circuit coupled with said user interface circuits, said host processor, said network modem, and said peripheral interface processor, said power management circuit operable to power up said network modem at predetermined intervals and at least sometimes wake up said peripheral interface processor in response to particular receptions of said modem, and further operable at times so that said user interface circuits and said host processor are each in a substantially power-reduced mode while said network modem and said peripheral interface processor are each in a more fully powered mode.

3. The networking device claimed in claim 1 wherein said peripheral interface processor is operable with said modem to act as a local station with its own station address, said peripheral interface processor having a storage for a set of other station addresses, said peripheral interface processor operable to detect a received station address other than own station address, and to automatically capture at least some content from wireless signals addressed to such received address provided the received address is among the set of station addresses.

4. The networking device claimed in claim 1 wherein said peripheral interface processor is operable with said modem to transmit trigger signals representing controls to trigger a content play application remotely.

5. The networking device claimed in claim 1 wherein said peripheral interface processor is further operable with said modem to receive a remotely-originated requestor address and trigger signals representing controls to pull local content from said local content storage and to transmit such pulled local content via said modem to said requestor address.

6. The networking device claimed in claim 5 wherein said peripheral interface processor is further operable to receive and detect a request to have the requested file locally displayed as well as transmitted, and to respond by locally displaying the file.

7. The networking device claimed in claim 1 further comprising local sensors, and sensor interface circuits coupled with said local sensors and with said host processor and with said peripheral interface processor as a sensor hub.

8. The networking device claimed in claim 1 wherein said local content storage is operable to hold content files by respective time of creation, and said peripheral interface processor has an address storage for a set of other station addresses, said peripheral interface processor operable with said modem to newly discover signals representing a station address already in the address storage and signifying a no-longer-absent network station, and further operable with said modem to send to that station address some updating signals representing information from said local content storage about content files having their time of creation during such absence.

9. The networking device claimed in claim 1 wherein said host processor and said peripheral interface processor are operable to share said modem as coordinated plural network media access controllers (MACs) so that one MAC can signal that it is commencing sleep and the other MAC can use said modem.

10. The networking device claimed in claim 1 further comprising a second network modem of the same networking type as said first-named network modem, and wherein said host processor is operable to communicate through said first modem and then to disable said first modem, and said peripheral interface processor is operable to transfer at least one content file through said second modem and is coupled to further request host processor to disable said first modem in case said peripheral interface processor is maintaining a connection by said second modem.

11. The networking device claimed in claim 1 wherein at least one of said host processor and said peripheral interface processor is operable to initiate a new electronic social group.

12. The networking device claimed in claim 1 wherein at least one of said host processor and said peripheral interface processor is operable to join an electronic social group.

13. The networking device claimed in claim 1 wherein said peripheral interface processor and said modem are operable as a wireless docking host having a configuration file and operable to use at least one dockee network address to parse a configuration file and configure at least one WSB (wireless serial bus) hub.

14. The networking device claimed in claim 13 wherein such host is operable to establish a separate secure channel based on the configuration file and for security credentials.

15. The networking device claimed in claim 1 wherein said peripheral interface processor is operable as a wireless docking host that includes a protected setup push-button configuration module, whereby to facilitate connections.

16. The networking device claimed in claim 1 wherein said peripheral interface processor and said modem are operable as wireless host station and substantially concurrently as a client station for distinct wireless connections.

17. A peripheral interface processor integrated circuit comprising:
a networking modem operable to receive signals carrying station addresses;
a plurality of data interface circuits; and
a programmable processor coupled with said modem and said interface circuits and operable to act as a local station with its own station address, said processor operable to detect a received station address other than own station address, to determine whether that received address is among a set of predetermined station addresses, and to capture at least some content from signals addressed to such received address provided the received address is among that set of station addresses.

18. The peripheral interface processor integrated circuit claimed in claim 17 wherein when the received address is among the set of station addresses, said programmable processor is operable to derive an index at least in part from that received address and to associate and store the index with the captured content.

19. The peripheral interface processor integrated circuit claimed in claim 17 wherein when the received address is among that set of station addresses, said programmable processor is operable to send a message to that received address indicating the content was captured.

20. The peripheral interface processor integrated circuit claimed in claim 17 wherein said programmable processor includes first programmable processor core and a second processor core coupled therewith and operable faster than said first processor core to execute content encodes and decodes and network processing.

21. The peripheral interface processor integrated circuit claimed in claim 17 wherein said programmable processor is operable to output trigger signals representing controls to trigger a content application remotely.

22. The peripheral interface processor integrated circuit claimed in claim 17 further comprising a local content storage coupled with said programmable processor and wherein said processor is operable to generate trigger signals representing controls to pull remote content and to subsequently store such content to said local content storage.

23. The peripheral interface processor integrated circuit claimed in claim 17 further comprising a local content storage coupled with said programmable processor and wherein said programmable processor is operable to receive and respond to a remotely-originated requestor address and trigger signals representing controls to pull local content from said local content storage and to generate signals representing controls to transmit such pulled local content, the generation of such signals conditioned on receiving an requestor address that is among that set of station addresses.

24. The peripheral interface processor integrated circuit claimed in claim 23 wherein said processor is further operable to receive and detect a request to have the requested file locally displayed as well as transmitted, and to respond by outputting control signals representing local displaying controls for the file.

25. The peripheral interface processor integrated circuit claimed in claim 17 further comprising a local sensor, and wherein said programmable processor is operable to automatically index a sensor capture, and said programmable processor is operable to generate signals representing controls to transmit a network address and to trigger automatic remote visibility at the address.

26. The peripheral interface processor integrated circuit claimed in claim 17 wherein said programmable processor has a storage holding instructions to discover remotely-located content associated with an approximate physical location, and to automatically stream such discovered content back to the processor.

27. The peripheral interface processor integrated circuit claimed in claim 17 wherein said programmable processor is operable to so capture at least some content from signals addressed to such received address provided the received address is that of a subordinate station in the network, and is prevented from such capture when the received address is that of a super-ordinate station.

28. A process of operating a networking circuit, the process comprising:
detecting a received station address other than own station address; and
capturing at least some content from signals addressed to such received address provided the received address is among a given set of station addresses.

29. The process claimed in claim 28 wherein when the received address is among that set of station addresses, deriving an index at least in part from that received address and associating the index with the captured content as a file.

30. The process claimed in claim 28 wherein when the received address is among that set of station addresses, sending a message to that received address indicating the content was captured.

31. The process claimed in claim 28 further comprising generating trigger signals representing controls to trigger a content play application remotely.

32. The process claimed in claim 28 further comprising generating trigger signals representing controls to pull remote content and to subsequently receive such content for a local content storage.

33. The process claimed in claim 28 further comprising receiving and responding to remotely-originated trigger signals representing controls to pull local content from a local content storage; and generating signals representing controls to transmit such pulled local content.

34. The process claimed in claim 33 further comprising receiving a request to locally display the requested file as well as transmit it, and to respond by locally displaying the file.

35. The process claimed in claim 28 further comprising generating interrogation signals to remotely access that set of other station addresses.

36. The process claimed in claim 28 further comprising electronically discovering remotely-located content and sending a pull request for such discovered content.

37. The process claimed in claim 28 wherein the networking circuit can be an electronic member of at least two electronic social groups and the captured content is available for automatic sharing in a first such electronic social group, and the process further comprises protecting the captured content that is available for automatic sharing in that first electronic social group from unintended automatic sharing in a second such electronic social group.

38. The process claimed in claim 28 wherein the networking circuit has local service class information, and the process further comprises sending a discovery probe request addressed to an network address remotely, receiving a discovery probe response with service class information available remotely, comparing at least one of the service class informations for compatibility with a given type of content and sending a request for shareable content of the given type provided the content is compatible with at least one of the local service class information and the service class information available remotely.

39. A process of operation of a content-sharing network server, the process comprising:
storing data beforehand that substantially represents a table indicating network stations of an electronic social group that may hold content remotely;
receiving a station network address that corresponds to a station indicated in the table, and receiving with that address a data entity including file name of content;
tagging the data entity with at least one identification indication of a station from the table;
automatically initiating a message to at least one station thus tagged, each such message including a link to the content thus tagged.

40. The process claimed in claim 39 wherein the entity also includes metadata indicating at least one relevant station and the process further comprises electronically using the metadata to limit the automatic message initiating to each relevant station only.

41. The process claimed in claim 39 further comprising electronically analyzing the data entity and using a result thereof to select at least one so-tabulated station, if any, that would be relevant for sharing the file name, and to restrict the automatic message initiating to each thus-selected relevant station.

42. The process claimed in claim 39 further comprising constituting a new electronic social group on a received request.

43. The process claimed in claim 39 further comprising executing in response to a received request a procedure to permit a station join an electronic social group including updating said table.

44. The process claimed in claim 39 wherein the data entity also includes content and link is directed to the server itself.

45. The process claimed in claim 39 wherein the link is directed substantially to the station address received.

46. An electronic circuit for a mobile device, the electronic circuit comprising:
a networking modem;
a storage device operable to hold a content file; and
a processor coupled with said networking modem to have a station MAC address and said processor coupled and operable with said storage device to store and tag such content file with at least one other MAC address, said processor further operable to make said storage device with tagged content file remotely discoverable upon receiving via said modem a remotely-originated discovery request including the other MAC address as originating MAC address of the discovery request.

47. The electronic circuit claimed in claim 46 wherein said processor is operable to close the storage device against subsequent remote discoverability of the same tagged content file by a second remotely-originated discovery request including the other MAC address, after that tagged content file has first been remotely discoverable.

48. The electronic circuit claimed in claim 46 wherein said discovery request is selected from the group consisting of: 1) sniffing, 2) wireless direct device discovery.

49. The electronic circuit claimed in claim 46 wherein said processor is operable to respond to the received discovery request including the other MAC address and to operate said networking modem to send the content file addressed to the other MAC address.
